(19) United States
(12) Patent Application Publication
(10) Pub. No.: US 2024/0070443 A1
(43) Pub. Date: Feb. 29, 2024

(54) NEURAL NETWORK DEVICE, GENERATION DEVICE, INFORMATION PROCESSING METHOD, GENERATION METHOD, AND RECORDING MEDIUM

(71) Applicant: NEC Corporation, Minato-ku Tokyo (JP)

(72) Inventor: Yusuke SAKEMI, Tokyo (JP)

(73) Assignee: NEC Corporation, Minato-ku Tokyo (JP)

(21) Appl. No.: 18/039,939

(22) PCT Filed: Dec. 11, 2020
(86) PCT No.: PCT/JP2020/046331

§ 371 Date: Jun. 1, 2023

(51) Int. Cl. G06N 3/049; G06N 3/063

(52) U.S. Cl. CPC G06N 3/049; G06N 3/063

(57) ABSTRACT

A neural network device includes: a time-scheme spiking neuron model that outputs a signal when an internal state quantity that evolves over time in accordance with a signal input clock time, becomes a threshold value or more; and a delay unit that outputs a signal obtained by changing, by a set time, a spike clock time that is represented by the output signal of the time-scheme spiking neuron model as a relative clock time with respect to a reference clock time.

### TECHNICAL FIELD

The present invention relates to a neural network device, a generation device, an information processing method, a generation method, and a recording medium.

### BACKGROUND ART

An example of a neural network is a spiking neural network (for example, see Patent Document 1). In a spiking neural network, a neuron model has an internal state called a membrane potential, and outputs a signal called a spike based on the time evolution of the membrane potential.

For example, when implementing a neural network using hardware, a spiking neural network is expected to have lower power consumption during computations than a neural network using a neuron model (called an artificial neural network) that does not have an internal state and performs computations without including a time element.

### PRIOR ART DOCUMENTS

### Patent Documents

Patent Document 1: Published Japanese translation No. 2013-546065 of PCT International Publication

### SUMMARY OF THE INVENTION

### Problems to be Solved by the Invention

If it is possible to generate a spiking neural network that is equivalent to an artificial neural network, an operation is possible in which an artificial neural network is used to perform high-precision learning, and then an equivalent spiking neural network is generated. As a result, it is possible to achieve both high-precision processing and a reduction in power consumption.

When generating a spiking neural network that is equivalent to an artificial neural network, it is preferable that the structure of the spiking neural network is as simple as possible.

An object of the present invention is to provide a neural network device, a generation device, an information processing method, a generation method, and a recording medium capable of solving the above problems.

### Means for Solving the Problem

According to a first example aspect of the present invention, a neural network device includes: a time-scheme spiking neuron model means that outputs a signal when an internal state quantity that evolves over time in accordance with a signal input clock time, becomes a threshold value or more; and a delay means that outputs a signal obtained by changing, by a set time, a spike clock time that is represented by the output signal of the time-scheme spiking neuron model means as a relative clock time with respect to a reference clock time.

According to a second example aspect of the present invention, a generation device includes: a base network generating means that generates a neural network, the neural network including a time-scheme spiking neuron model means that outputs a signal when an internal state quantity that evolves over time in accordance with a signal input clock time, becomes a threshold value or more, and a delay means that outputs a signal obtained by changing, by a set time, a spike clock time that is represented by the output signal of the time-scheme spiking neuron model means as a relative clock time with respect to a reference clock time; a weight setting means that sets a weight of an input signal to the time-scheme spiking neuron model means to a weight based on an equation in which, when an input clock time of the input signal is a clock time in which a sign of a numerical value represented by the input signal is reversed, an output clock time of an output signal of the delay means becomes a clock time in which a sign of a numerical value represented by the output signal is reversed; and a delay setting means that sets the set time of the delay means to a time based on an equation in which, when an input clock time of an input signal to the time-scheme spiking neuron model means is a clock time in which a sign of a numerical value represented by the input signal is reversed, an output clock time of an output signal of the delay means becomes a clock time in which a sign of a numerical value represented by the output signal is reversed.

According to a third example aspect of the present invention, an information processing method includes: outputting a first signal when an internal state quantity that evolves over time in accordance with a signal input clock time, becomes a threshold value or more; and outputting a second signal obtained by changing, by a set time, a spike clock time that is represented by the first signal as a relative clock time with respect to a reference clock time.

According to a fourth example aspect of the present invention, a neural network generation method includes: generating a neural network, the neural network including a time-scheme spiking neuron model means that outputs a signal when an internal state quantity that evolves over time in accordance with a signal input clock time, becomes a threshold value or more, and a delay means that outputs a signal obtained by changing, by a set time, a spike clock time that is represented by the output signal of the time-scheme spiking neuron model means as a relative clock time with respect to a reference clock time; setting a weight of an input signal to the time-scheme spiking neuron model means to a weight based on an equation in which, when an input clock time of the input signal is a clock time in which a sign of a numerical value represented by the input signal is reversed, an output clock time of an output signal of the delay means becomes a clock time in which a sign of a numerical value represented by the output signal is reversed; and setting the set time of the delay means to a time based on an equation in which, when an input clock time of an input signal to the time-scheme spiking neuron model means is a clock time in which a sign of a numerical value represented by the input signal is reversed, an output clock time of an output signal of the delay means becomes a clock time in which a sign of a numerical value represented by the output signal is reversed.

According to a fifth example aspect of the present invention, a recording medium stores a program that causes a computer to execute: outputting a first signal when an internal state quantity that evolves over time in accordance with a signal input clock time, becomes a threshold value or more; and outputting a second signal obtained by changing, by a set time, a spike clock time that is represented by the first signal as a relative clock time with respect to a reference clock time.

According to a sixth example aspect of the present invention, a recording medium records a program for causing a computer to execute: generating a neural network, the neural network including a time-scheme spiking neuron model means that outputs a signal when an internal state quantity that evolves over time in accordance with a signal input clock time, becomes a threshold value or more, and a delay means that outputs a signal obtained by changing, by a set time, a spike clock time that is represented by the output signal of the time-scheme spiking neuron model means as a relative clock time with respect to a reference clock time; setting a weight of an input signal to the time-scheme spiking neuron model means to a weight based on an equation in which, when an input clock time of the input signal is a clock time in which a sign of a numerical value represented by the input signal is reversed, an output clock time of an output signal of the delay means becomes a clock time in which a sign of a numerical value represented by the output signal is reversed; and setting the set time of the delay means to a time based on an equation in which, when an input clock time of an input signal to the time-scheme spiking neuron model means is a clock time in which a sign of a numerical value represented by the input signal is reversed, an output clock time of an output signal of the delay means becomes a clock time in which a sign of a numerical value represented by the output signal is reversed.

### Effect of Invention

According to the neural network device, generation device, information processing method, generation method, and recording medium described above, the configuration of a spiking neural network that is equivalent to an artificial neural network can be made a relatively simple configuration.

### BRIEF DESCRIPTION OF THE DRAWINGS

FIG. 1 A schematic block diagram showing a configuration example of a neural network generation device according to an example embodiment.

FIG. 2 A diagram showing an example of the hierarchical structure of a feed-forward neural network.

FIG. 3 A diagram showing a configuration example of a feed-forward neural network.

FIG. 4 A diagram showing a ramp function.

FIG. 5 A schematic block diagram showing a configuration example of an artificial neuron model.

FIG. 6 A diagram showing an example of time evolution of the membrane potential of a spiking neuron.

FIG. 7 A diagram showing an example of spikes in a time scheme.

FIG. 8 A diagram showing an example of the correspondence between an artificial neural network and a spiking neural network according to an example embodiment.

FIG. 9 A diagram showing a configuration example of a t-ReLU layer according to an example embodiment.

FIG. 10 diagram showing an example of input and output clock times of spikes in a t-ReLU layer according to an example embodiment.

FIG. 11 A schematic block diagram showing a configuration example of a time adjustment-type spiking neuron model according to an example embodiment.

FIG. 12 A diagram showing a configuration example of a time-scheme spiking neuron model according to an example embodiment.

FIG. 13 A schematic configuration diagram showing a configuration example of a synaptic circuit according to an example embodiment.

FIG. 14 A flowchart showing an example of a processing procedure by which a neural network generation device according to an example embodiment transforms an artificial neural network into a spiking neural network.

FIG. 15 A schematic block diagram showing a configuration example of a neuron model generation device according to an example embodiment.

FIG. 16 A flowchart showing an example of a processing procedure by which a neuron model generation device according to an example embodiment transforms an artificial neuron model into a time adjustment-type spiking neuron model.

FIG. 17 A diagram showing an example of output clock times of spikes in a spiking neural network according to an example embodiment.

FIG. 18 A diagram showing an example of output clock times of spikes in an artificial neural network and a spiking neural network according to an example embodiment.

FIG. 19 A diagram showing an example of time evolution of the membrane potential of the neuron models in a hidden layer in a case where a delay time according to an example embodiment is reflected.

FIG. 20 A diagram showing an example of time evolution of the membrane potential of the neuron models in a hidden layer in a case where a delay time according to an example embodiment is not reflected.

FIG. 21 A diagram showing an example of time evolution of the membrane potential of the neuron models in an output layer in a case where a delay time according to an example embodiment is reflected.

FIG. 22 A diagram showing an example of time evolution of the membrane potential of the neuron models in an output layer in a case where a delay time according to an example embodiment is not reflected.

FIG. 23 A diagram showing a configuration example of a neural network device according to an example embodiment.

FIG. 24 A diagram showing a configuration example of a generation device according to an example embodiment.

FIG. 25 A diagram showing an example of a processing procedure of an information processing method according to an example embodiment.

FIG. 26 A diagram showing an example of a processing procedure of a generation method according to an example embodiment.

FIG. 27 A schematic block diagram showing a configuration of a computer according to at least one example embodiment.

### EXAMPLE EMBODIMENT

Hereunder, an example embodiment of the present embodiment will be described. However, the following example embodiment does not limit the invention according to the claims. Furthermore, all combinations of features described in the example embodiment may not be essential to the solution means of the invention.

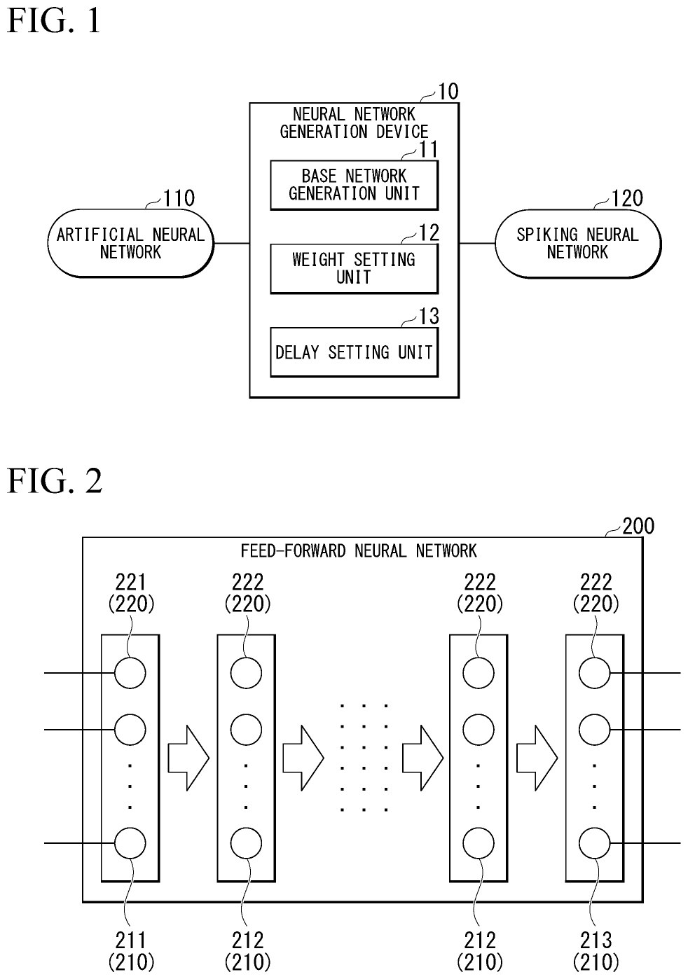

FIG. 1 is a schematic block diagram showing a configuration example of a neural network generation device according to an example embodiment. In the configuration shown in FIG. 1, the neural network generation device 10 includes a base network generation unit 11, a weight setting unit 12, and a delay setting unit 13.

The neural network generation device is also simply referred to as a generation device.

The neural network generation device 10 acquires configuration information of a non-memory type neural network 110, and generates a spiking neural network (SNN) 120 that is equivalent to the non-memory type neural network. The neural network generation device 10 may generate a spiking neural network device as the spiking neural network 120.

Here, two neural networks are equivalent when the two neural networks can be regarded as outputting the same information in response to the same input information. The term “regarded” here means that the format in which the information is represented may be different.

Furthermore, errors due to differences in the format of the neural networks and errors due to differences in the format in which the information is represented are allowed. For example, two neural networks are equivalent when the two neural networks theoretically output information with the same content in response to input information with the same content.

Here, a neuron model that calculates a weighted sum of the input values, inputs the calculated value or a value obtained by adding a bias value to the sum, to an activation function, and outputs the obtained function value, is referred to as a non-memory type neuron model. A neural network configured using non-memory type neuron models is referred to as a non-memory type neural network.

A non-memory type neural network is also referred to as an artificial neural network (ANN). A non-memory type neuron model is also referred to as an artificial neuron model.

The spiking neural network referred to here is a neural network configured using spiking neuron models. The spiking neuron models referred to here is a general term for neuron models that output a binary signal called a spike based on an internal state that evolves over time. The binary signal referred to here may be an on/off signal. The internal state of a spiking neuron model is referred to as a membrane potential.

The spiking neural network 120 generated by the neural network generation device 10 has a structure for forming a neural network that is equivalent to the artificial neural network 110. The spiking neural network 120, which has a structure for forming a neural network that is equivalent to the artificial neural network 110, is also referred to as a time adjustment-type spiking neural network. The neuron models used in a time adjustment type spiking neural network are also referred to as time adjustment-type spiking neuron models.

The neural network device referred to here is a device in which a neural network is implemented. The neural network may be implemented using dedicated hardware, or may be implemented by software using a computer or the like. A device in which an artificial neural network is implemented is also referred to as an artificial neural network device. A device in which a spiking neural network is implemented is also referred to as a spiking neural network device.

### (Feed-Forward Neural Network)

The neural network generation device 10 handles a feed-forward neural network. That is to say, the neural network generation device 10 acquires the configuration information of a feed-forward artificial neural network 110, and generates a feed-forward spiking neural network 120 that is equivalent to the artificial neural network 110.

A feed-forward network is a form of network, and is a network in which information transmission at the connections from layer to layer is in one direction. Each layer of a feed-forward neural network is configured by one or more neuron models, and there are no connections between the neuron models in the same layer.

FIG. 2 is a diagram showing an example of the hierarchical structure of a feed-forward neural network. As illustrated in FIG. 2, the feed-forward neural network 200 is configured with a hierarchical structure, receives a data input, and then outputs a computation result. The computation result output by a neural network is also referred to as a predictive value or a prediction.

The first layer of a feed-forward neural network is referred to as the input layer, and the last layer is referred to as the output layer. The layers between the input layer and the output layer are referred to as hidden layers. The number of hidden layers may be 0 or more. Therefore, a feed-forward neural network does not have to include hidden layers.

In the example of FIG. 2, the feed-forward neural network 200 includes an input layer 211, hidden layers 212, and an output layer 213. The input layer 211, the hidden layers 212, and the output layer 213 are collectively referred to as layers 210.

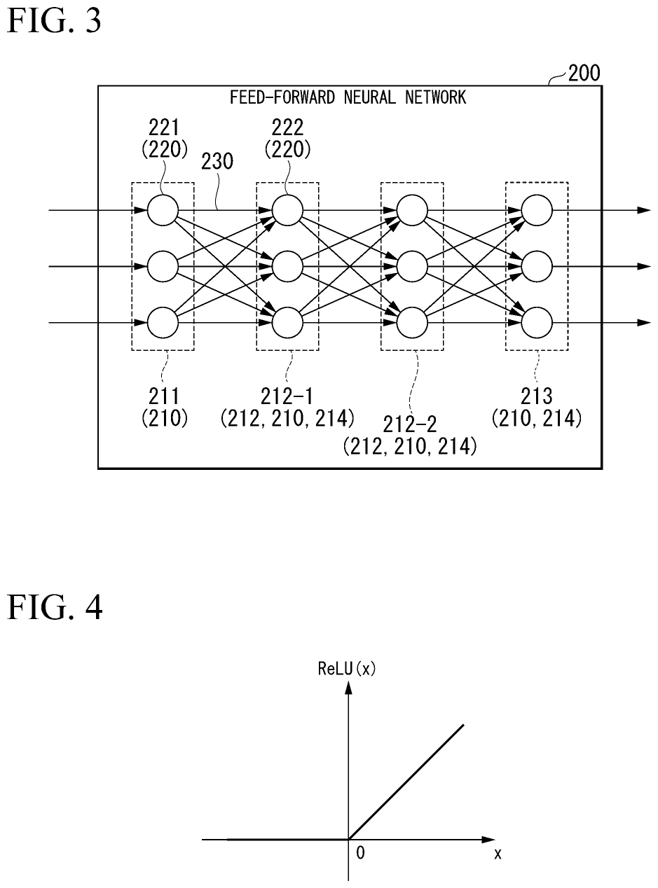

FIG. 3 is a diagram showing a configuration example of the feed-forward neural network 200. FIG. 3 shows an example of a case where the feed-forward neural network 200 includes four layers 210, namely an input layer 211, two hidden layers 212, and an output layer 213. When distinguishing between the two hidden layers 212, the upper layer is referred to as the hidden layer 212-1, and the lower layer is referred to as the hidden layer 212-2. The upper layer referred to here is the side closer to the input layer 211. The lower layer is the side closer to the output layer 213.

FIG. 3 shows an example in which the four layers 210 each have three nodes 220. However, the number of nodes 220 included in the feed-forward neural network 200 is not limited to a specific number, and each layer 210 may include one or more nodes 220. Each of the layers 210 may have the same number of nodes 220, or different layers 210 may have different numbers of nodes 220.

As illustrated in FIG. 3, the nodes of two adjacent layers 210 are connected by edges 230. The edges 230 transmit signals from the upper-layer nodes to the lower-layer nodes.

Between two adjacent layers 210, all combinations of upper-layer nodes 220 and lower-layer nodes 220 may be connected by an edge 230. Alternatively, there may be combinations that are not connected by an edge 230.

Among the nodes 220, the nodes 220 in the input layer 211 distribute the input signal to the nodes 220 in the next layer 210. The nodes 220 in the input layer 211 are also referred to as input nodes 221.

On the other hand, the nodes 220 in the hidden layers 212 and the nodes 220 in the output layer 213 each use a neuron model. The nodes 220 in the hidden layers 212 and the nodes 220 in the output layer 213 are also collectively referred to as neuron model nodes 222. The hidden layers 212 and the output layer 213 are also collectively referred to as neuron model layers 214.

In the artificial neural network 110, artificial neuron models are used as the neuron model nodes 222. In the spiking neural network 120, spiking neuron models are used as the neuron model nodes 222.

Hereunder, when there is no need to distinguish between the input nodes 221 and the neuron model nodes 222, the nodes 220 are treated as neuron models. In particular, when a neuron model constituting a lower-layer node 220 acquires a signal from an upper-layer node 220, a signal is output regardless of whether the upper-layer node 220 is an input node 221 or a neuron model node 222, and there is no need for a distinction to be made in the description. In this case, the upper-layer node 220 is treated as a neuron model in the description.

### (Artificial Neural Network)

As mentioned above, the artificial neural network 110 is a neural network configured using artificial neuron models. An artificial neuron model is a neuron model that calculates a weighted sum of the input values, inputs the calculated value or a value obtained by adding a bias value to the sum to an activation function, and outputs the obtained function value.

The output value of an artificial neuron model is expressed as in equation (1).

$$[ Math . 1 ]$$

$${x}_{i}^{( l )} = f ( {\sum }_{j} {w}_{ij}^{( l )} {x}_{j}^{( l - 1 )} + {b}_{i}^{( l )} ) \qquad ( 1 )$$

x^{(l)}ᵢ represents the output of the ith artificial neuron model in the lth layer. w^{(l)}ᵢⱼ is a coefficient that represents the strength of the connection from the jth artificial neuron model in the (l−1)th layer to the ith artificial neuron model in the lth layer, and is referred to as a weight. When the jth artificial neuron model in the (l−1)th layer and the ith artificial neuron model in the lth layer are not connected by an edge 230, this is represented by w^{(l)}ᵢⱼ=0.

“ⱼw^{(l)}ᵢⱼx^{(l-1)}ⱼ” represents the weighted sum of the input values described above. b^{(l)}ᵢ is referred to as a bias term, and represents the bias described above. f represents an activation function.

In the learning phase, the value of the weight w^{(l)}ᵢⱼ and the value of the bias term b^{(l)}ᵢ are updated by learning.

Of the transformation shown in equation (1), the portion of the transformation excluding the activation function can be grasped as an affine transformation, and is represented as in equation (2).

$$[ Math . 2 ]$$

$$Affine ( {x}^{( l - 1 )} ) = {\sum }_{j} {w}_{ij}^{( l )} {x}_{j}^{( l - 1 )} + {b}_{i}^{( l )} \qquad ( 2 )$$

x^{(l-1)} represents an output vector (x^{(l-1)}ₗ, . . . , x^{(l-1)}_{N(l-1)}) of the artificial neuron models in the (l−1)th layer. N^{l-1)} represents the number of artificial neuron models in the (l−1)th layer.

“Affine” represents an affine function (a function representing an affine transformation).

An example of using a ramp function as the activation function f will be described below. A ramp function is also referred to as a rectified linear function.

FIG. 4 is a diagram showing a ramp function. The horizontal axis of the graph in FIG. 4 represents the input to the ramp function, that is to say, the argument value of the ramp function. The vertical axis represents the output of the ramp function, that is to say, the function value of the ramp function. As shown in FIG. 4, the ramp function is represented by ReLU. Furthermore, in FIG. 4, the input to the ramp function is represented by x.

As shown in FIG. 4, when the input x is x≥0, then ReLU(x)=x. On the other hand, when the input x is x<0, then ReLU(x)=0. The ramp function ReLU is expressed as in equation (3).

[Math. 3]

ReLU(x)=max(0, x) (3)

“max” is a function that outputs the maximum value among the arguments.

However, the activation function of the artificial neuron model is not limited to a ramp function. Various functions that can be expressed in a time-scheme as described below can be used as the activation function of an artificial neuron model.

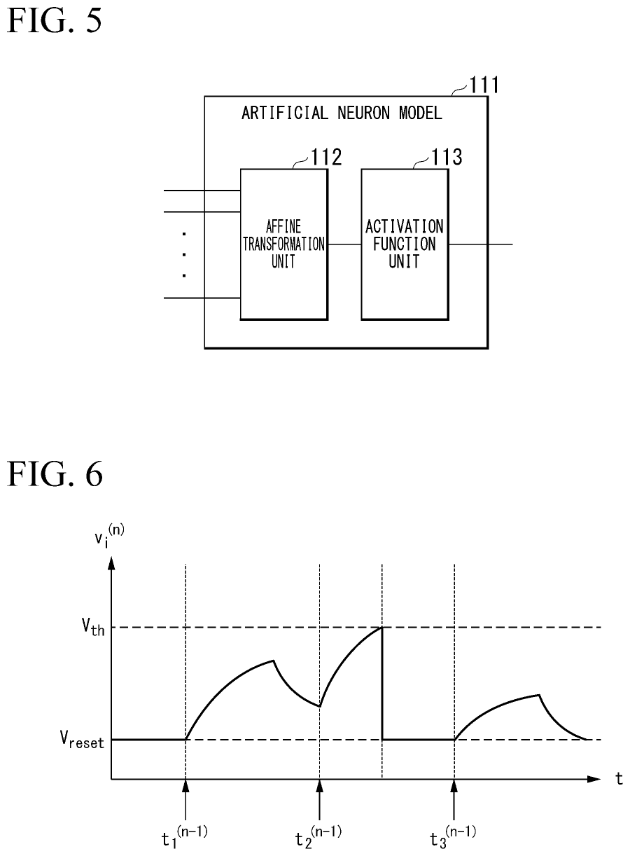

FIG. 5 is a schematic block diagram showing a configuration example of an artificial neuron model. In the configuration shown in FIG. 5, the artificial neuron model 111 includes an affine transformation unit 112 and an activation function unit 113.

The affine transformation unit 112 obtains a weighted sum of the inputs to the artificial neuron model 111, and adds a bias value to the obtained sum. For example, the affine transformation unit 112 calculates Affine(X^{(l-1)}) based on equation (2) above.

The activation function unit 113 performs the computation of the activation function in the artificial neuron model 111. For example, the activation function unit 113 computes the function value ReLU(Affine(x^{(l-1)}) by inputting the value of Affine(x^{(l-1)}) computed by the affine transformation unit 112 into the ramp function ReLU.

### (Spiking Neural Network)

As mentioned above, a spiking neural network is a neural network configured using spiking neuron models. A spiking neuron model outputs a binary signal called a spike based on an internal state that evolves over time.

As a result, a spiking neuron model simulates signal integration and spike generation (firing) by the cell body of a biological neuron.

For example, in a leaky integrate-and-fire neural network, which is a type of spiking neuron model, the membrane potential evolves over time according to a differential equation such as in equation (1).

$$[ Math . 4 ]$$

$$\frac{d}{dt} {v}_{i}^{( n )} ( t ) = - {α}_{leak} {v}_{i}^{( n )} ( t ) + {I}_{i}^{( n )} ( t ) , {I}_{i}^{( n )} ( t ) = {\sum }_{j} {w}_{ij}^{′ ( n )} r ( t - {t}_{j}^{( n - 1 )} ) \qquad ( 4 )$$

v⁽ⁿ⁾ᵢ represents the membrane potential of the ith spiking neuron model in the nth layer. weak is a constant coefficient representing the magnitude of a leak in the leaky integrate-and-fire model. I⁽ⁿ⁾ᵢ represents the postsynaptic current of the ith spiking neuron model in the nth layer. w′⁽ⁿ⁾ᵢⱼ is a coefficient that represents the strength of the connection from the jth spiking neuron model in the (n−1)th layer to the ith spiking neuron model in the nth layer, and is referred to as a weight.

t represents time. t⁽ⁿ⁻¹⁾ⱼ represents the firing timing (firing clock time) of the jth neuron in the (n−1)th layer. r(·) is a function representing the effect a spike transmitted from a preceding layer has on the postsynaptic current.

When the membrane potential reaches a threshold value Vₜₕ, the spiking neuron model outputs a spike. The threshold value Vₜₕ is a threshold value that simulates an action potential. As mentioned above, a spike is a binary signal output by a spiking neuron model. When a spiking neuron model outputs a spike, this is also referred to as firing. Depending on the type of spiking neuron model, the membrane potential may return to a reset value Vᵣₑₛₑₜ after firing.

The spike output by the spiking neuron model is transmitted to the lower-layer spiking neuron models connected to the spiking neuron model.

FIG. 6 is a diagram showing an example of time evolution of the membrane potential of a spiking neuron. The horizontal axis of the graph in FIG. 6 represents the clock time, and the vertical axis the membrane potential. FIG. 6 shows an example of the time evolution in the membrane potential of the ith spiking neuron in the nth layer, and the membrane potential is represented by v⁽ⁿ⁾ᵢ.

As mentioned above, Vₜₕ represents the threshold value of the membrane potential. Vᵣₑₛₑₜ represents the reset value of the membrane potential. t⁽ⁿ⁻¹⁾₁ represents the firing timing of the first neuron in the (n−1)th layer. t⁽ⁿ⁻¹⁾₂ represents the firing timing of the second neuron in the (n−1)th layer. t⁽ⁿ⁻¹⁾₃ represents the firing timing of the third neuron in the (n−1)th layer.

At both the first firing at time t⁽ⁿ⁻¹⁾₁ and the third firing at time to t⁽ⁿ⁻¹⁾₃, the membrane potential v⁽ⁿ⁾ᵢ does not reach the threshold value Vₜₕ. On the other hand, at the second firing at time t⁽ⁿ⁻¹⁾₂, the membrane potential v⁽ⁿ⁾ᵢ reaches the threshold value Vth and then immediately drops to the reset value Vᵣₑₛₑₜ.

A spiking neural network is expected to consume less power than a deep learning model when implemented by hardware such as a CMOS (Complementary MOS). One reason for this is that the human brain is a computing medium having a low power consumption equivalent to 30 watts (W), and a spiking neural network can mimic the activity of a brain having such a low power consumption.

For example, because a spiking neural network uses binary signals, the power consumption due to the signals can be reduced compared to a case where analog signals are used in an artificial neural network.

### (Information Transmission Method of Spiking Neural Network)

The neural network generation device 10 uses a time scheme as the information transmission method of the spiking neural network 120. In a time scheme, information is transmitted using firing timings.

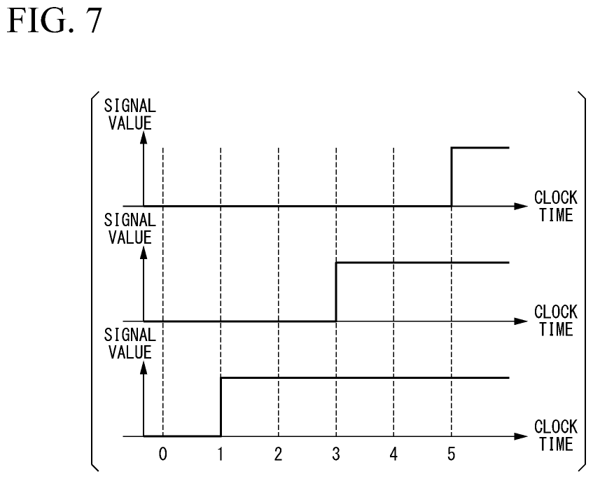

FIG. 7 is a diagram showing an example of spikes in a time scheme. The horizontal axis of FIG. 7 represents the clock time. Specifically, the horizontal axis represents the relative clock time with respect to clock time “0”, which is the reference clock time. The vertical axis represents the signal value.

FIG. 7 shows three examples, namely an example of a case where firing occurs at clock time “1”, an example of a case where firing occurs at clock time “3”, and an example of a case where firing occurs at clock time “5”. In a time scheme, a spiking neuron model is capable of representing quantitative information by the firing clock time. For example, the spike may represent the numerical value of the firing clock time, such that a spike fired at clock time “3” represents the numerical value “3”. That is to say, a spiking neuron model may represent a numerical value by the length of time between the reference clock time and the firing clock time.

The firing clock time is not limited to an integer clock time, and the spiking neuron model may represent a real value by the firing clock time.

FIG. 7 shows an example of using a step signal as a spike. However, it is not limited to this. It is possible to use spikes having various shapes that can represent the firing clock time. For example, a pulse signal that rises and then falls after a certain period of time may be used as a spike. In this case, as a result of the signal turning off, a further reduction in the power consumption due to the signal can be expected compared to the case of a step signal.

Furthermore, in a time scheme, each spiking neuron model may fire at most once. As a result, the power consumption due to the signal can be reduced compared to the frequency method in which a numerical value is represented by the number of spikes.

A spiking neural network using a time scheme is also referred to as a time-scheme spiking neural network. A spiking neuron using a time scheme is also referred to as a time-scheme spiking neuron.

### (Learning by Spiking Neural Network)

As described above, according to the spiking neural network 120, a reduction in power consumption is expected compared to a case where the artificial neural network 110 is used. On the other hand, the artificial neural network 110 is considered to be able to perform highly accurate learning more easily than the spiking neural network 120.

Therefore, the neural network generation device 10 may generate a spiking neural network 120 that is equivalent to the trained artificial neural network 110. For example, the neural network generation device 10 may generate a spiking neural network 120 that is equivalent to the trained artificial neural network 110, as a spiking neural network device. As a result, it is possible to achieve both highly accurate execution of computations and a reduction in power consumption.

### (Artificial Neural Network and Equivalent Spiking Neural Network)

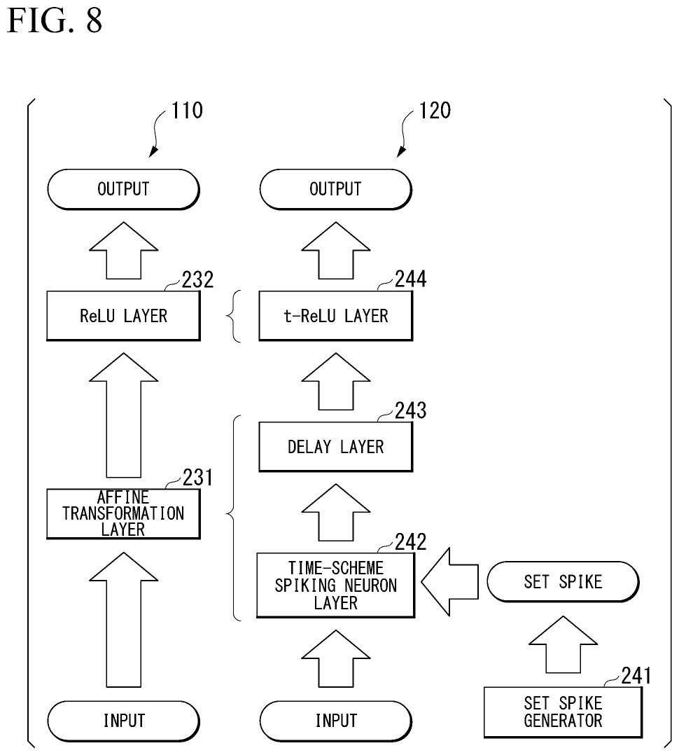

FIG. 8 is a diagram showing an example of the correspondence between the artificial neural network 110 and the spiking neural network 120. In order to generate a spiking neural network 120 that is equivalent to the artificial neural network 110, a single layer of the neural network is further subdivided into a plurality of layers.

FIG. 8 shows a configuration example of the equivalent of one neuron model layer 214 in the feed-forward neural network 200. As mentioned above, the neuron model layer 214 is a hidden layer 212 or an output layer 213.

In the following, the generation of a spiking neural network 120 that is equivalent to an artificial neural network 110 is also referred to as transforming an artificial neural network 110 into a spiking neural network 120. The generation of part of a spiking neural network 120 that corresponds to part of an artificial neural network 110 is also referred to as transformation (of that part).

Furthermore, in the following, a single neuron model layer 214 in the artificial neural network 110 is referred to as a target layer, and a case will be described where the neural network generation device 10 converts the target layer into a neuron model layer 214 of the spiking neural network 120. The neural network generation device 10 converts each and every neuron model layer 214 included in the artificial neural network 110 into a neuron model layer 214 of the spiking neural network 120.

In the case of the artificial neural network 110, a single neuron model layer 214 can be grasped as a combination of an affine transformation layer 231 and a ReLU layer 232.

A grouping of the affine transformation units 112 of all of the artificial neuron models 111 included in the single neuron model layer 214 corresponds to an example of the affine transformation layer 231.

A grouping of the activation function units 113 of all of the artificial neuron models 111 included in the single neuron model layer 214 corresponds to an example of the ReLU layer 232.

The neural network generation device 10 provides a set spike generator 241, a time-scheme spiking neuron layer 242, and a delay layer 243 with respect to the affine transformation layer 231. Furthermore, the neural network generation device 10 provides a t-ReLU layer 244 with respect to the ReLU layer 232.

The time-scheme spiking neuron layer 242 includes time-scheme spiking neuron models. The neural network generation device 10 generates a time-scheme spiking neuron layer 242 that includes the same number of time-scheme spiking neuron models as the number of artificial neuron models 111 included in the target layer.

In the following, in order to make the equations easier to understand, it is assumed that the number of neuron models in the lth layer, which is the target layer, is one, and the number of neuron models in the (l−1)th layer is N. Further, the symbol 1 representing the layer number and the symbol i representing the neuron model number in the lth layer are omitted. Moreover, the neuron model number in the (l−1)th layer, which is represented above by j, is instead represented by i.

When the number of artificial neuron models in the target layer of the artificial neural network 110 is two or more, the neural network generation device 10 may perform the processing described below for each artificial neuron model in the target layer. Furthermore, when the number of neuron model layers 214 in the artificial neural network 110 is two or more, the neural network generation device 10 may perform the processing described below, with each of the neuron model layers 214 as the target layer.

It is assumed that the neural network generation device 10 uses time-scheme spiking neuron models having a leak magnitude (αₗₑₐₖ) of 0 in the time-scheme spiking neuron layer 242, such that equation (4) is transformed into equation (5).

$$\begin{matrix}[ Math . 5 ] & \\ \frac{d}{dt} v ( t ) = {\sum }_{i = 0}^{N} {w}_{i}^{⋀} θ ( t - {t}_{i} ) & ( 5 )\end{matrix}$$

t represents time. v represents the membrane potential. w\hat{ }ᵢ application Ser. represents the weight of the connection from the ith spiking neuron in the upper layer.

In equation (5), the step function θ is used as the function r in equation (4). The step function θ is expressed as in equation (6).

$$\begin{matrix}[ Math . 6 ] & \\ θ ( t ) = \{ \begin{matrix}0 & ( t < 0 ) \\ 1 & ( 0 \leq t )\end{matrix} & ( 6 )\end{matrix}$$

As shown in FIG. 8, each of the time-scheme spiking neuron models in the time-scheme spiking neuron layer 242 accepts, in addition to the spikes from the upper layer, a set spike input from the set spike generator 241.

In equation (5), the spikes from the upper layer are represented by i=1, . . . , N, and the set spike is represented by i=0. Specifically, t₁, . . . , t_{N} represent the input clock times of the spikes from the upper layer. to represents the input clock time of the set spike.

The set spike generator 241 outputs a set spike at a set clock time (clock time t₀) that does not depend on the value of the input data to the spiking neural network 120. The set clock time may be updateable by learning or the like.

Equation (7) is obtained by integrating equation (5).

$$\begin{matrix}[ Math . 7 ] & \\ v ( t ) = {\sum }_{i = 0}^{N} {w}_{i}^{⋀} ( t - {t}_{i} ) θ ( t - {t}_{i} ) & ( 7 )\end{matrix}$$

The firing clock time of the time-scheme spiking neuron model is given by equation (8), where v(t) in equation (7)=Vₜₕ.

$$\begin{matrix}[ Math . 8 ] & \\ t = \frac{{V}_{t h} + {\sum }_{i = 0}^{N} {w}_{i}^{⋀} {t}_{i}}{{\sum }_{i = 0}^{N} {w}_{i}^{⋀}} & ( 8 )\end{matrix}$$

It is assumed that all input spikes have been input by the firing clock time.

The delay layer 243 delays the output spike of the time-scheme spiking neuron. Assuming a delay time τ of the delay layer 243, the spike output clock time of the delay layer 243 is given by equation (9).

$$\begin{matrix}[ Math . 9 ] & \\ t = \frac{{V}_{t h} + {\sum }_{i = 0}^{N} {w}_{i}^{⋀} {t}_{i}}{{\sum }_{i = 0}^{N} {w}_{i}^{⋀}} + τ & ( 9 )\end{matrix}$$

It is assumed that the delay time τ can be set arbitrarily.

Furthermore, the output of the affine transformation layer 231 of the artificial neural network 110 is given by equation (10) when the input to the affine function “Affine” in equation (2) is expressed as x=(x₁, X₂, . . . , xₙ).

$$\begin{matrix}[ Math . 10 ] & \\ Affine ( x ) = {\sum }_{i = 1}^{N} {w}_{i} {x}_{i} + b & ( 10 )\end{matrix}$$

In equation (10), the symbols l and i representing the layer number and the spiking neuron number of the spiking neuron are omitted, and corresponds to an equation in which the symbol j in equation (2) is replaced by i.

As the spiking neural network 120 that is equivalent to the artificial neural network 110, the output value of the affine transformation layer 231 of the artificial neural network 110 is considered to be represented by the spike output clock time of the delay layer 243 of the spiking neural network 120.

Specifically, when the spike input clock time to the spiking neuron model is −x=(−x₁, −x₂, . . . , −xₙ), the spike output clock time becomes −Σᵢ₌₁^{N}wᵢxᵢ−b. In equation (9), when tᵢ=−xᵢ(i=1, 2, . . . , N) and t=−Σᵢ₌₁^{N}wᵢxᵢ−b, equation (11) is obtained.

$$\begin{matrix}[ Math . 11 ] & \\ - {\sum }_{i = 1}^{N} {w}_{i} {x}_{i} - b = \frac{{V}_{t h} + {w}_{0}^{⋀} {t}_{0} - {\sum }_{i = 1}^{N} {w}_{i}^{⋀} x}{{\sum }_{i = 0}^{N} {w}_{i}^{⋀}} + τ & ( 11 )\end{matrix}$$

Equation (11) should hold regardless of the value of xᵢ. In order to satisfy this, a condition for wᵢ is represented as in equation (12).

$$\begin{matrix}[ Math . 12 ] & \\ {w}_{i} = \frac{{w}_{i}^{⋀}}{{\sum }_{i = 0}^{N} {w}_{i}^{⋀}} & ( 12 )\end{matrix}$$

The condition for b is represented as in equation (13).

$$\begin{matrix}[ Math . 13 ] & \\ - b = \frac{{w}_{0}^{⋀} {t}_{0} + {V}_{th}}{{\sum }_{i = 0}^{N} {w}_{i}^{⋀}} + τ & ( 13 )\end{matrix}$$

Equation (11) holds regardless of the value of xᵢ as long as equation (12) and equation (13) are satisfied.

The delay time τ in equation (13) can take any value. Expression (13) can be easily satisfied by adjusting the value of the delay time τ.

Further, equation (14) is obtained by transforming equation (12).

[Math. 14]

wᵢw\hat{ }₁w+wᵢw\hat{ }₁+ . . . +)wᵢ−1)w\hat{ }ᵢ+ . . . +wᵢ\hat{ }_{N}=−wᵢw\hat{ }₀ (10)

When equation (14) is collected for i=1, 2, . . . , N, it can be represented as equation (15).

$$\begin{matrix}[ Math . 15 ] & \\ ( \begin{matrix}{w}_{1} - 1 & {w}_{1} & … & {w}_{1} \\ {w}_{2} & {w}_{2} - 1 & … & {w}_{2} \\ ⋮ & ⋮ & ⋱ & ⋮ \\ {w}_{N} & … & … & {w}_{N} - 1\end{matrix} ) ( \begin{matrix}{w}_{1}^{⋀} \\ {w}_{2}^{⋀} \\ ⋮ \\ {w}_{N}^{⋀}\end{matrix} ) = - {w}_{0}^{⋀} ( \begin{matrix}{w}_{1} \\ {w}_{2} \\ ⋮ \\ {w}_{N}\end{matrix} ) & ( 15 )\end{matrix}$$

Here, the matrix A is defined as in equation (16).

$$\begin{matrix}[ Math . 16 ] & \\ ( \begin{matrix}{w}_{1} - 1 & {w}_{1} & … & {w}_{1} \\ {w}_{2} & {w}_{2} - 1 & … & {w}_{2} \\ ⋮ & ⋮ & ⋱ & ⋮ \\ {w}_{N} & … & … & {w}_{N} - 1\end{matrix} ) = A & ( 16 )\end{matrix}$$

The weights w\hat{ }₁, w\hat{ }₂, . . . , w\hat{ }_{N} in the time-scheme spiking neuron layer 242 can be calculated as in equation (17).

$$\begin{matrix}[ Math . 17 ] & \\ ( \begin{matrix}{w}_{1}^{⋀} \\ {w}_{2}^{⋀} \\ ⋮ \\ {w}_{N}^{⋀}\end{matrix} ) = - {w}_{0}^{⋀} {A}^{- 1} ( \begin{matrix}{w}_{1} \\ {w}_{2} \\ ⋮ \\ {w}_{N}\end{matrix} ) & ( 17 )\end{matrix}$$

The matrix A⁻¹ is the inverse of the matrix A. The delay time τ can be calculated by inputting the values of the weights w\hat{ }ᵢ calculated in equation (17) into equation (18).

$$\begin{matrix}[ Math . 18 ] & \\ τ = - \frac{{w}_{0}^{⋀} {t}_{0} + {V}_{th}}{{\sum }_{i} {w}_{i}^{⋀}} - b & ( 18 )\end{matrix}$$

As shown in equation (18), the delay time τ can be negative. The information of the spiking neural network in each layer is represented by the clock time difference of each neuron. That is to say, even if all neurons in a certain layer are delayed by the same clock time, the output of the entire network is delayed by that amount, and the same information can be expressed regardless of the magnitude of the delay time. For this reason, it is possible to arbitrarily add an amount common to a certain layer as the delay time. That is to say, when the delay time τ calculated by equation (18) is negative, a delay amount common to the target layer may be appropriately added so that the delay time τ becomes positive.

As mentioned above, when the number of artificial neuron models in the target layer of the artificial neural network 110 is two or more, the neural network generation device 10 may perform processing for each artificial neuron model in the target layer. Furthermore, when the number of neuron model layers 214 in the artificial neural network 110 is two or more, the neural network generation device 10 may perform the processing with each of the neuron model layers 214 as the target layer.

When the target layer is represented as the lth layer, the neuron model number in the target layer is represented by i, and the neuron model number in the upper layer of the target layer is represented by j, equation (17) is expressed as equation (19).

$$\begin{matrix}[ Math . 19 ] & \\ ( \begin{matrix}{w}_{i 1}^{⋀ ( l )} \\ {w}_{i 2}^{⋀ ( l )} \\ ⋮ \\ {w}_{iN}^{⋀ ( l )}\end{matrix} ) = - {{w}_{i 0}^{⋀ ( l )} ( {A}_{i}^{( i )} )}^{- 1} ( \begin{matrix}{w}_{i 1}^{( l )} \\ {w}_{i 2}^{( l )} \\ ⋮ \\ {w}_{iN}^{( l )}\end{matrix} ) & ( 19 )\end{matrix}$$

w\hat{ }^{(l)}ᵢⱼ represents the weight of the connection from the jth spiking neuron model in the (l−1)th layer to the ith spiking neuron model in the lth layer. However, w\hat{ }^{(l)}ᵢ₀ represents the weight of the set spike.

The matrix (A¹⁾ᵢ)⁻¹ is the inverse matrix of the matrix A^{l)}ᵢ in which the weights wⱼ(j=1, 2, . . . , N) on the left side of equation (16) are represented by w^{(l)}ᵢⱼ.

Equation (18) is expressed as in equation (20).

$$\begin{matrix}[ Math . 20 ] & \\ {τ}_{i}^{( l )} = - \frac{{w}_{i 0}^{⋀ ( l )} {t}_{0}^{( l - 1 )} + {V}_{t h ( i )}^{( l )}}{{\sum }_{j = 0}^{N} {w}_{ij}^{⋀ ( l )}} - {b}_{i}^{( l )} & ( 20 )\end{matrix}$$

τᵢ^{(l)} represents the delay time from the delay layer 243 for the output spike of the ith time-scheme spiking neuron model in the lth time-scheme spiking neuron layer 242.

t^{l-1)}₀ represents the spike input clock time from the set spike generator 241 to the ith time-scheme spiking neuron model in the lth time-scheme spiking neuron layer 242.

Vₜₕ^{(l)}₍ᵢ₎ represents the threshold value of the membrane potential of the ith time-scheme spiking neuron model in the lth time-scheme spiking neuron layer 242. As mentioned above, the threshold value simulates an action potential.

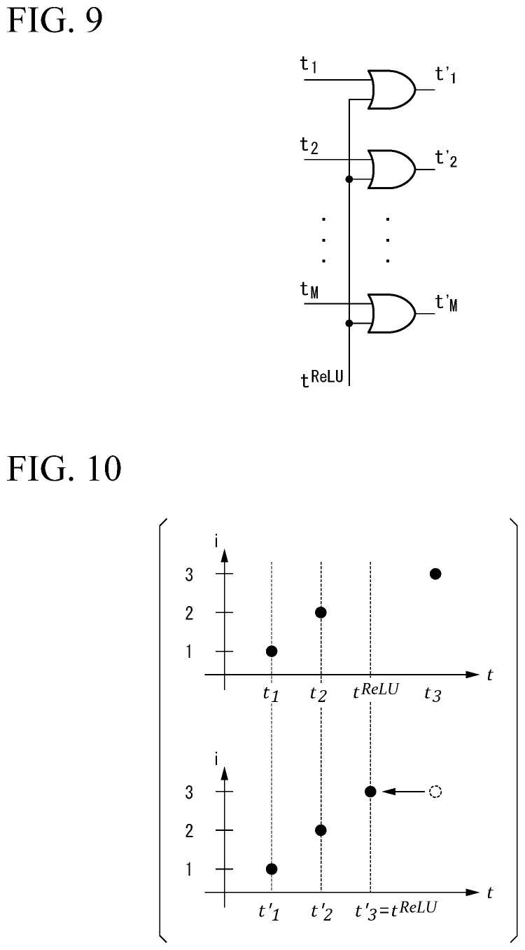

FIG. 9 is a diagram showing a configuration example of the t-ReLU layer 244.

In FIG. 9, the number of time-scheme spiking neurons included in the time-scheme spiking neuron layer 242 is represented by M.

The M spikes from the delay layer 243 to the t-ReLU layer 244 are each input at the clock times t₁, t₂, . . . , t_{M}. Further, the set spike is input at clock time t^{ReLU}. The set spike of the t-ReLU layer 244 is a different spike from the set spike of the time-scheme spiking neuron layer 242. The set spike of the t-ReLU layer 244 is also referred to as a t-ReLU spike.

The spike output clock times of the t-ReLU layer become t′₁, t′₂, . . . , t′_{M}.

In FIG. 9, an OR of each of the input spikes to the t-ReLU layer and the set spike is taken. As a result, the t-ReLU layer outputs a spike at the earlier of the spike input clock times tᵢ to the t-ReLU layer and the clock time t^{ReLU} of the set spike.

The spike output clock times t′ᵢ (i=2, 2, . . . , M) are represented as in equation (21).

[Math. 21]

t′ᵢ=min(t^{ReLU}, tᵢ) (2 1)

As shown in FIG. 9 and equation (21), the t-ReLU layer 244 outputs spikes at the clock times t′ᵢ, which are the earlier of the clock time tᵢ and the clock time t^{ReLU}.

FIG. 10 is a diagram showing an example of input and output clock times of spikes in the t-ReLU layer 244. The horizontal axis of the graph in FIG. 10 represents the clock time, and the vertical axis represents the identification number i of the upper layer node. The identification number of the upper layer node is also used as a spike identification number.

FIG. 10 shows a case where the number of input spikes to the t-ReLU layer 244 is three.

In the upper graph of FIG. 10, the spike input clock times t₁, t₂ and t₃ to the t-ReLU layer 244 are shown. In the lower graph of FIG. 10, the spike output clock times t′₁, t′₂ and t′₃ from the t-ReLU layer 244 are shown.

As mentioned above, the t-ReLU layer 244 outputs spikes at the clock times t′ᵢ which are the earlier of the clock time t₁ and the clock time t^{ReLU}. In the example of FIG. 10, the clock times t₁and t₂are both earlier than the clock time t^{ReLU}, and thus, t′₁=t₁ and t′₂=t₂ are satisfied.

On the other hand, the clock time t₃ is later than the clock time t^{ReLU}, and thus, t′₃=t^{ReLU} is satisfied.

Now assume that t^{ReLU}=0. That is to say, assume that the ReLU spike is input to the t-ReLU layer 244 at the reference clock time t=0. As a result, the right side of equation (21) becomes the same function as the ramp function (see equation (3)) except that the signs of the input and output are reversed. In this regard, it can be said that the t-ReLU layer 244 applies a ramp function to the spike output clock time.

When the neural network generation device 10 transforms the artificial neural network 110 into the spiking neural network 120, it may provide a neuron model of the spiking neural network 120 for each artificial neuron model. As mentioned above, in this case, the neuron model is also referred to as a time adjustment-type spiking neuron model.

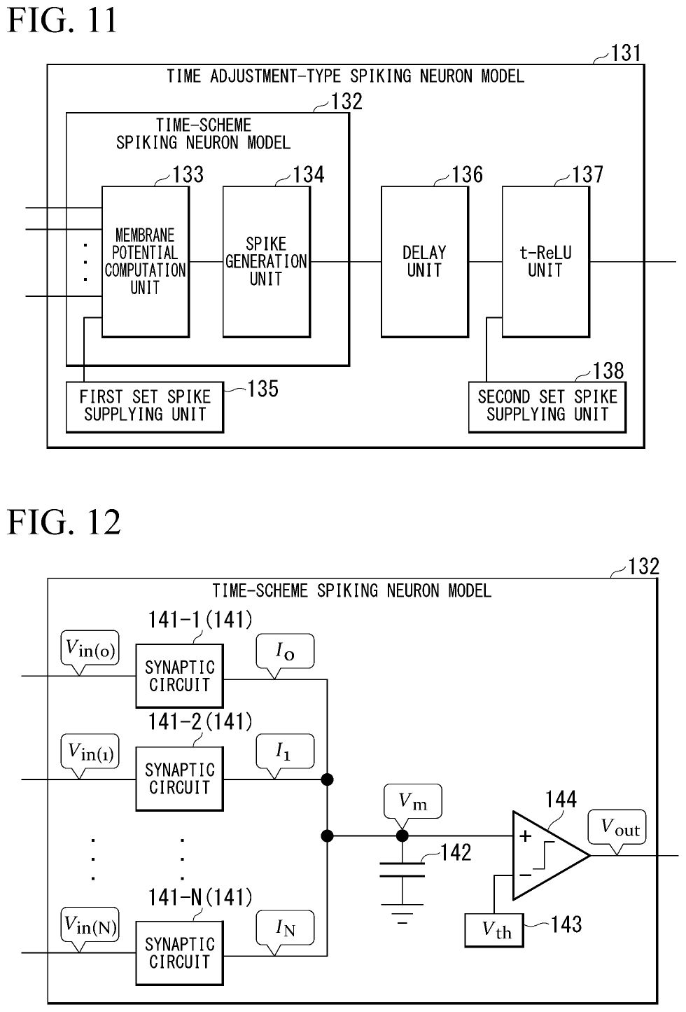

FIG. 11 is a schematic block diagram showing a configuration example of a time adjustment-type spiking neuron model. In the configuration shown in FIG. 11, the time adjustment-type spiking neuron model 131 includes a time-scheme spiking neuron model 132, a first set spike supplying unit 135, a delay unit 136, a t-ReLU unit 137, and a second set spike supplying unit 138. The time-scheme spiking neuron model 132 includes a membrane potential computation unit 133 and a spike generation unit 134.

The time-scheme spiking neuron model 132 corresponds to an example of the time-scheme spiking neuron model in the time-scheme spiking neuron layer 242 described above.

The membrane potential computation unit 133 computes the membrane potential of the time-scheme spiking neuron model 132 based on equation (5).

The spike generation unit 134 compares the membrane potential calculated by the membrane potential computation unit 133 and the threshold value. When it is determined that the membrane potential is the threshold value or more, the spike generation unit 134 outputs a spike.

FIG. 12 is a diagram showing a configuration example of the time-scheme spiking neuron model 132. In the configuration shown in FIG. 12, the time-scheme spiking neuron model 132 includes N synaptic circuits 141-1 to 141-N, a capacitor 142, a threshold power supply 143, and a comparator 144.

The synaptic circuits 141-1 to 141-N are also collectively referred to as a synaptic circuit 141.

The synaptic circuit 141 switches the current to the capacitor 142 on and off in response to a spike from the time adjustment-type spiking neuron model 131 in the upper layer. Furthermore, the synaptic circuit 141 weights the current to the capacitor 142.

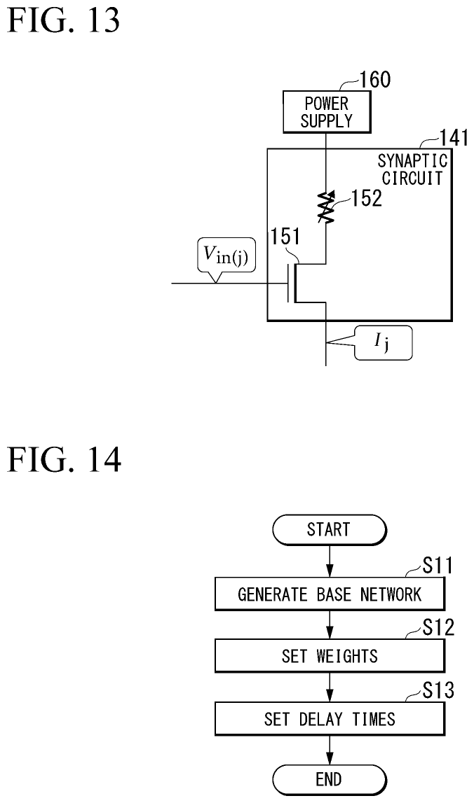

FIG. 13 is a schematic configuration diagram showing a configuration example of the synaptic circuit 141. In the configuration shown in FIG. 13, the synaptic circuit 141 includes a switching element 151 and a variable resistor 152. Furthermore, the synaptic circuit 141 is connected to a power supply 160.

In the example of FIG. 13, the power supply 160, the variable resistor 152, and the switching element 151 are connected in series.

The power supply 160 provides current for the output current of the synaptic circuit 141.

The switching element 151 switches the output current of the synaptic circuit 141 on and off in response to an input signal. The input signal referred to here is a spike from the time adjustment-type spiking neuron model 131 in the upper layer.

In FIG. 13, the input signal to the synaptic circuit 141-j (where j is an integer satisfying 0≤j≤N) is represented by a voltage Vino). Moreover, the output current from the synaptic circuit 141-j is represented by Ii.

A step signal may be used as a spike. Then, the switching element 151 may turn on the current while the spike is input and turn off the current while the spike is not input. Turning on the current may represent passing (electrifying with) a current. Turning off the current may represent not passing (not electrifying with) a current.

The variable resistor 152 adjusts the amount of current that flows when the switching element 151 turns on the current. For example, the potential of the power supply 160 may be constant, and a current inversely proportional to the resistance value of the variable resistor 152 may be output from the synaptic circuit 141 according to Ohm's law.

The capacitor 142 generates a potential by storing the output current of the synaptic circuit 141. FIG. 12 represents the potential of the capacitor as Vₘ. The potential Vₘ represents the membrane potential.

The threshold power supply 143 supplies a threshold potential to be compared with the membrane potential (potential Vₘ).

The comparator 144 changes the output signal when the membrane potential reaches a threshold potential. Specifically, the comparator 144 outputs a spike by changing the output voltage of the comparator 144 itself when the membrane potential becomes the threshold potential or more. In FIG. 12, the output signal of the comparator 144 is represented by the voltage Vₒᵤₜ.

The combination of the synaptic circuit 141 and the capacitor 142 corresponds to an example of the membrane potential computation unit 133. The combination of the threshold power supply 143 and the comparator 144 corresponds to an example of the spike generation unit 134.

However, the implementation method of the time-scheme spiking neuron model 132 is not limited to a specific method. For example, the neural network generation device 10 may implement the time-scheme spiking neuron model 132 on a computer as software.

The delay unit 136 delays the output spike of the time-scheme spiking neuron model 132 by a set delay time. As a result, the delay unit 136 executes a delay of the spike in the delay layer 243.

The t-ReLU unit 137 performs processing with respect to the spike output by the delay unit 136 for a case where t^{ReLU}=0 in equation (21). Specifically, when the t-ReLU unit 137 receives a spike input from the delay unit 136 before the reference clock time at which the clock time t=0, it outputs the spike as it is at the timing it receives the spike input. On the other hand, when the t-ReLU unit 137 does not receive a spike input from the delay unit 136 before clock time t=0, it outputs the spike input from the second set spike supplying unit 138 at clock time t=0 as it is at the timing it receives the spike input.

As a result, the t-ReLU unit 137 applies the ramp function to the spike output clock time of the t-ReLU layer 244.

The second set spike supplying unit 138 outputs a spike at clock time t=0. As mentioned above, when a spike input is not received from the delay unit 136 before clock time t=0, the t-ReLU unit 137 outputs a spike at clock time t=0 by outputting the ramp function output by the second set spike supplying unit 138 as it is.

Here, by aligning the reference clock times of all the spiking neuron models included in one layer of the spiking neural network 120 to the same timing, the reference clock times of the spikes input to the lower layer can be aligned. Therefore, the spiking neural network 120 may be provided with a second set spike supplying unit 138 for each layer.

A case where the spiking neural network 120 is configured using the time adjustment-type spiking neuron model 131 will be considered.

In this case, the first set spike supplying unit 135 corresponds to an example of the set spike generator 241.

Furthermore, the time-scheme spiking neuron models 132 of all of the time adjustment-type spiking neuron models 131 included in one neuron model layer 214, when collectively perceived as a layer, correspond to an example of the time-scheme spiking neuron layer 242.

Moreover, the delay units 136 of all of the time adjustment-type spiking neuron models 131 included in one neuron model layer 214, when collectively perceived as a layer, correspond to an example of the delay layer 243.

In addition, the t-ReLU units 137 of all of the time adjustment-type spiking neuron models 131 included in one neuron model layer 214, when collectively perceived as a layer, correspond to an example of the t-ReLU layer 244.

The base network generation unit 11 generates the spiking neural network 120 in a state where the weights of the time-scheme spiking neuron layer 242 and the delay time of the delay layer 243 can be set. The spiking neural network 120 in this state is also referred to as a base network.

The weight setting unit 12 sets the weights of the time-scheme spiking neuron layer 242 of the spiking neural network 120 generated by the base network generation unit 11. For example, the weight setting unit 12 calculates the weights w\hat{ }^{(l)}ᵢⱼ based on equation (19), and sets the time-scheme spiking neuron layer 242 with the calculated weights w\hat{ }^{(l)}ᵢⱼ.

The delay setting unit 13 sets the delay times of the delay layer 243 of the spiking neural network 120 generated by the base network generation unit 11. For example, the delay setting unit 13 calculates the delay times τ^{(l)}ᵢ based on equation (20), and sets the delay layer 243 with the calculated delay times τ^{(l)}ᵢ.

FIG. 14 is a flowchart showing an example of a processing procedure by which the neural network generation device 10 transforms the artificial neural network 110 into the spiking neural network 120.

In the processing of FIG. 14, the base network generation unit 11 generates the spiking neural network 120 in a state where the weights of the time-scheme spiking neuron layer 242 and the delay time of the delay layer 243 can be set (step S11).

Then, the weight setting unit 12 sets the weights of the time-scheme spiking neuron layer 242 of the spiking neural network 120 generated by the base network generation unit 11 (step S12).

Then, the delay setting unit 13 sets the delay times of the delay layer 243 of the spiking neural network 120 generated by the base network generation unit 11 (step S13).

After step S13, the neural network generation device 10 ends the processing of FIG. 14.

The transformation from the artificial neuron model 111 to the time adjustment-type spiking neuron model 131 may be performed on a neuron model basis.

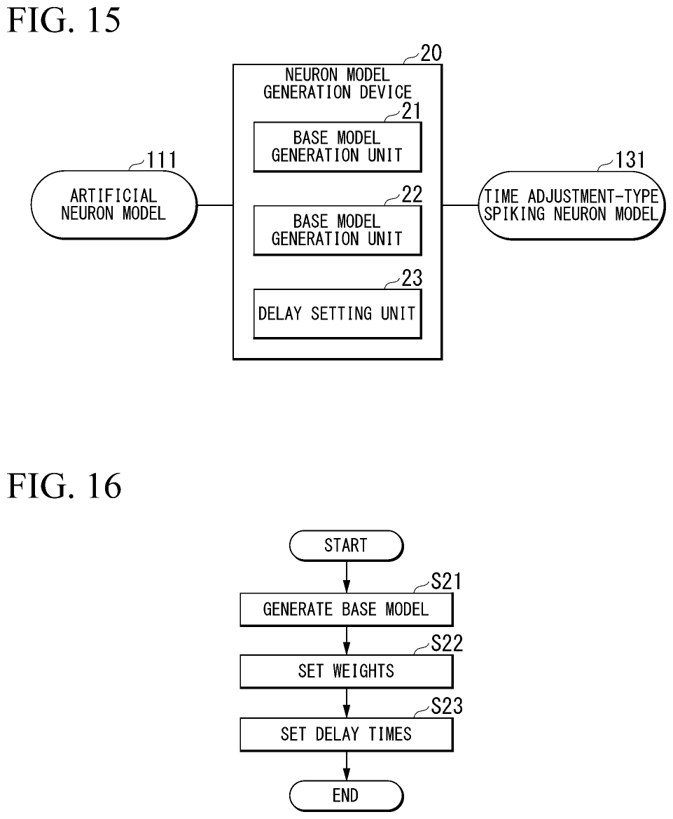

FIG. 15 is a schematic block diagram showing a configuration example of a neuron model generation device according to an example embodiment. In the configuration shown in FIG. 15, the neuron model generation device 20 includes a base model generation unit 21, a weight setting unit 22, and a delay setting unit 23.

The neuron model generation device 20 acquires the configuration information of the artificial neuron models 111, and generates time adjustment-type spiking neuron models 131 that are equivalent to the artificial neuron models 111. The neuron model generation device 20 may generate time adjustment-type spiking neuron model devices as the time adjustment-type spiking neuron models 131.

The base model generation unit 21 generates the time adjustment-type spiking neuron models 131 in a state where the weights of the time-scheme spiking neuron models 132 and the delay times of the delay units 136 can be set. The time adjustment-type spiking neuron models 131 in this state are referred to as base models.

The weight setting unit 22 sets the weights of the time-scheme spiking neuron models 132 of the time adjustment-type spiking neuron models 131 generated by the base model generation unit 21. For example, the weight setting unit 22 calculates the weights w\hat{ }^{(l)}ᵢbased on equation (19), and sets the time-scheme spiking neuron models 132 with the calculated weights w\hat{ }^{(l)}ᵢ).

The delay setting unit 23 sets the delay times of the delay units 136 of the time-scheme spiking neuron models 132 generated by the base model generation unit 21. For example, the delay setting unit 23 calculates the delay times τ^{(l)}ᵢ based on equation (20), and sets the delay units 136 with the calculated delay times τ^{(l)}ᵢ ).

FIG. 16 is a flowchart showing an example of a processing procedure by which the neuron model generation device 20 transforms the artificial neuron model 111 into the time adjustment-type spiking neuron model 131.

In the processing of FIG. 16, the base model generation unit 21 generates the time adjustment-type spiking neuron models 131 in a state where the weights of the time-scheme spiking neuron models 132 and the delay times of the delay units 136 can be set (step S21).

Next, the weight setting unit 22 sets the weights of the time-scheme spiking neuron models 132 of the time adjustment-type spiking neuron models 131 generated by the base model generation unit 21 (step S22).

Then, the delay setting unit 23 sets the delay times of the delay units 136 of the time-scheme spiking neuron models 132 generated by the base model generation unit 21 (step S23).

After step S23, the neuron model generation device 20 ends the processing of FIG. 16.

In this way, the neural network generation device 10 generates a time-scheme spiking neural network 120 that is equivalent to the artificial neural network 110.

According to the neural network generation device 10, by using the time-scheme spiking neural network 120, it is possible to reduce the power consumption while also performing the same computations as the artificial neural network 110.

All or part of the neural network generation device 10 may be implemented by dedicated hardware.

All or part of the neural network generation device 10 may be implemented by an ASIC (Application Specific Integrated Circuit) or an FPGA (Field-Programmable Gate Array).

All or part of the spiking neural network 120 generated by the neural network generation device 10 may be implemented by dedicated hardware.

All or part of the spiking neural network 120 may be implemented by an ASIC or an FPGA.

The time-scheme spiking neuron layer 242 corresponds to an example of the time-scheme spiking neuron model means, and is configured using time-scheme spiking neuron models.

The delay layer 243 corresponds to an example of the delay means, and outputs a spike at a clock time in which the spike output clock times of the time-scheme spiking neuron layer 242 have been changed by a set time.

The t-ReLU layer 244 corresponds to an example of the time-scheme ramp function means, and outputs a signal at the earlier of the spike output clock time of the delay layer 243 and the reference clock time.

The set spike generator 241 corresponds to an example of the set spike supplying means, and outputs a spike to the time-scheme spiking neuron layer 242 at a clock time that does not depend on the input signal to the time-scheme spiking neuron layer 242.

The time-scheme spiking neuron model 132 corresponds to an example of the time-scheme spiking neuron model means, and is configured using time-scheme spiking neuron models.

The delay unit 136 corresponds to an example of the delay means, and outputs a spike at a clock time in which the spike output clock time of the time-scheme spiking neuron model 132 has been changed by a set time.

The t-ReLU unit 137 corresponds to an example of the time-scheme ramp function means, and outputs a signal at the earlier of the spike output clock time of the delay unit 136 and the reference clock time.

The first set spike supplying unit 135 corresponds to an example of the set spike supplying means, and outputs a spike to the time-scheme spiking neuron model 132 at a clock time that does not depend on the input signal to the time-scheme spiking neuron model 132.

The base network generation unit 11 corresponds to an example of the base network generating means, and generates a spiking neural network 120 including a time-scheme spiking neuron layer 242 and a delay layer 243.

The weight setting unit 12 corresponds to an example of the weight setting means, and sets the weights of the input spikes to the time-scheme spiking neuron layer 242 to the weights or w\hat{ }ᵢ or w\hat{ }^{(l)}ᵢⱼ based on equation (17) or equation (19).

Equation (17) and equation (19) are examples of an equation that, when the input clock times tᵢ or t^{l-1})ⱼ of the input spikes to the time-scheme spiking neuron layer 242 are the clock times −xᵢ or −x^{(l-1})ⱼ in which the sign of the numerical values represented by the input spikes have been reversed, causes the output clock times t or t^{l-1})ᵢ of the output spikes of the delay layer 243 to become the clock times Σᵢ₌₁^{N}wᵢxᵢ−b or Σᵢ₌₁^{N}w^{(l)}ᵢⱼx^{(l-1)}ⱼ−b^{(l)}ᵢ, in which the sign of the numerical values represented by the output spikes have been reversed.

The delay setting unit 13 is an example of the delay setting means, and sets the set time of the delay layer 243 to the delay time τ or τ^{(l)}ᵢ based on equation (18) or equation (20).

Equation (18) and equation (20) are examples of an equation that, when the input clock times tᵢ or t^{(l-11)}ⱼ of the input spikes to the time-scheme spiking neuron layer 242 are the clock times −xᵢ or −x⁻¹⁾ⱼ in which the sign of the numerical values represented by the input spikes have been reversed, causes the output clock times t or t^{(l)}ᵢ of the output spikes of the delay layer 243 to become the clock times Σᵢ₌₁^{N}wᵢxᵢ−b or Σᵢ₌₁^{N}w^{(l)}ᵢⱼx^{(l-1)}ⱼ−b^{(l)}ᵢ, in which the sign of the numerical values represented by the output spikes have been reversed.

The base model generation unit 21 corresponds to an example of the base model generation means, and generates time adjustment-type spiking neuron models 131 including a time-scheme spiking neuron model 132 and a delay unit 136.

The weight setting unit 22 corresponds to an example of the weight setting means, and sets the weights of the input spikes to the time-scheme spiking neuron models 132 to the weights or w\hat{ }ᵢ or w\hat{ }^{(l)}ᵢⱼ based on equation (17) or equation (19).

The delay setting unit 23 is an example of the delay setting means, and sets the set time of the delay unit 136 to the delay time τ or τ^{(l)}ᵢ based on equation (18) or equation (20).

Next, an example of transforming the artificial neural network 110 into the spiking neural network 120 will be described. The configuration of the artificial neural network 110 subjected to the transformation has a 4-3-3 configuration. That is to say, the input data has four dimensions (the number of input data is four), the number of neuron models in the hidden layer is three, and the number of neuron models in the output layer is three.

The artificial neural network 110 has been made to learn an iris data set by a general method of deep learning. For the learning, an iris classification data set composed of 150 four-dimensional vectors and label data linked to the four-dimensional vectors in a one-to-one correspondence has been used.

Then, the trained artificial neural network 110 has been transformed into a spiking neural network 120.

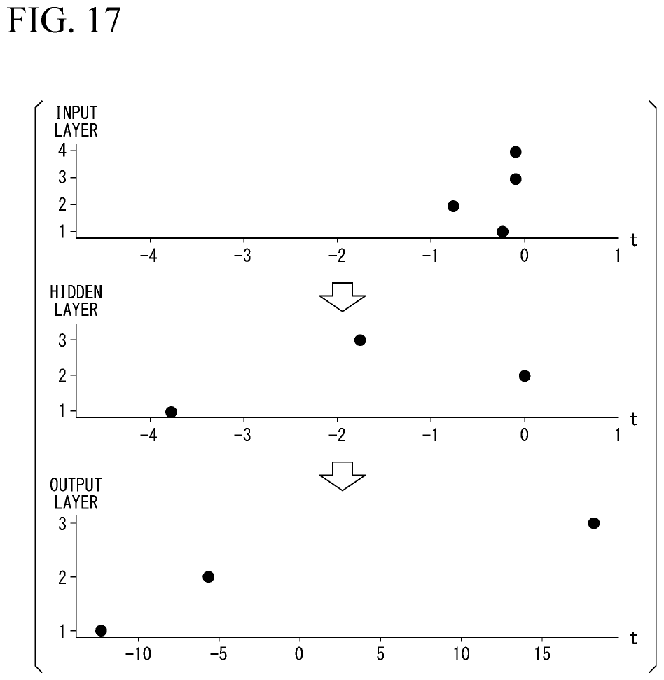

FIG. 17 is a diagram showing an example of output clock times of spikes in the spiking neural network 120. FIG. 17 shows the output clock times of the spikes of each of the input layer, the hidden layer, and the output layer in the processing of the same input data to the spiking neural network 120. The horizontal axis of each graph in FIG. 17 represents the clock time. The vertical axis represents the spike identification number i. As mentioned above, the identification number of the upper layer node is also used as a spike identification number.

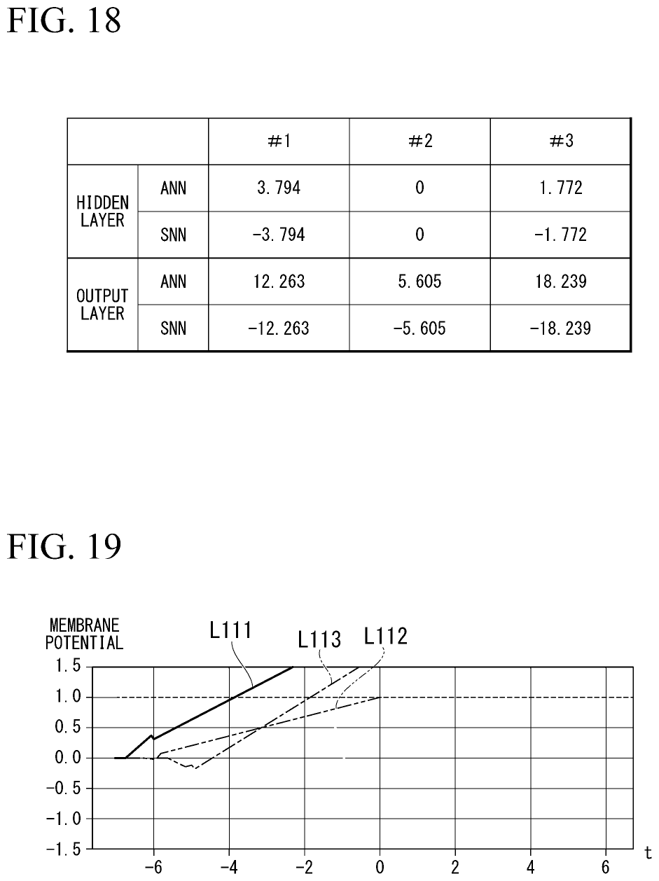

FIG. 18 is a diagram showing an example of output clock times of spikes in the artificial neural network 110 and the spiking neural network 120 according to an example embodiment. FIG. 18 shows the output values for each of the hidden layer and the output layer in the processing of the input data in the example of FIG. 17 for each of the artificial neural network 110 and the spiking neural network 120. The labels “#1”, “#2” and “#3” in FIG. 18 represent the identification numbers 1, 2 and 3 of each spike.

In the example of FIG. 18, the output values of the neuron models in the hidden layer of the artificial neural network 110 are 3.794, 0, and 1.772 in order from the first neuron model. In contrast, the spike output clock times of the neuron models in the hidden layer of the spiking neural network 120 are −3.794, 0, and −1.772 in order from the first neuron model.

Furthermore, the output values of the neuron models in the output layer of the artificial neural network 110 are 12.263, 5.605, and 18.239 in order from the first neuron model. In contrast, the spike output clock times of the neuron models in the hidden layer of the spiking neural network 120 are −12.263, −5.605, and −18.239 in order from the first neuron model.

In this way, for each node in the intermediate layer and the output layer, values in which the sign of the output values of the artificial neural network 110 have been reversed are the output values of the spiking neural network 120.

In this regard, the output values of the neuron models in the spiking neural network 120 are shown to be equivalent to the output values of the neuron models in the artificial neural network 110.

FIG. 19 is a diagram showing an example of time evolution in the membrane potential of the neuron models in a hidden layer in a case where the delay time is reflected. FIG. 19 shows an example of the time evolution of the membrane potential in the processing of the input data in the example of FIG. 17.

The horizontal axis of the graph in FIG. 19 represents the clock time. The vertical axis represents the membrane potential. A membrane potential value of 1.0 is set as the threshold value for firing. Furthermore, the clock times shown in FIG. 19 reflect the delay time τ or τ^{(l)}ᵢ shown in equation (18) or (20).

The line L111 represents an example of time evolution of the membrane potential of the first neuron model. The membrane potential of the first neuron model reaches the threshold value at the clock time −3.7994 as shown in FIG. 18.

The line L112 represents an example of time evolution of the membrane potential of the second neuron model. The membrane potential of the second neuron model reaches the threshold value at a clock time after clock time 0 as shown in FIG. 18.

The line L113 represents an example of time evolution of the membrane potential of the third neuron model. The membrane potential of the third neuron model reaches the threshold value at the clock time −1.772 as shown in FIG. 18.

In this way, the firing clock times in the case of FIG. 19 are values in which the sign of the output values of the artificial neuron model are reversed.

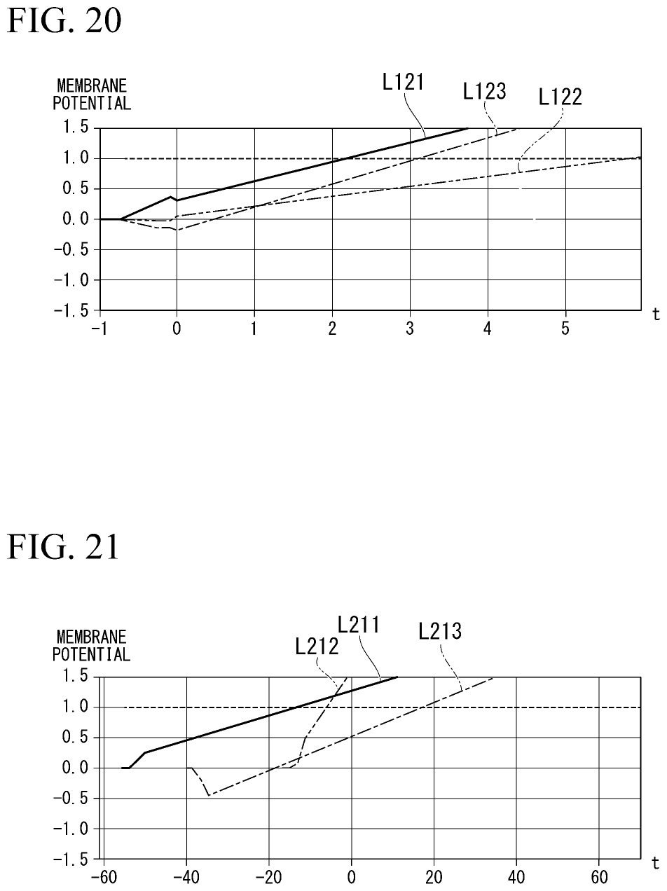

FIG. 20 is a diagram showing an example of time evolution in the membrane potential of the neuron models in a hidden layer in a case where a delay time is not reflected. FIG. 20 shows an example of the time evolution of the membrane potential in the processing of the input data in the example of FIG. 17.

The horizontal axis of the graph in FIG. 20 represents the clock time. The vertical axis represents the membrane potential. A membrane potential value of 1.0 is set as the threshold value for firing. Furthermore, the clock times shown in FIG. 20 do not reflect the delay time τ or τ^{(l)}ᵢ shown in equation (18) or (20).

The line L121 represents an example of time evolution of the membrane potential of the first neuron model. The line L122 represents an example of time evolution of the membrane potential of the second neuron model. The line L123 represents an example of time evolution of the membrane potential of the third neuron model.

The firing clock times in the case of FIG. 20 are different from the firing clock times in the case of FIG. 19. Therefore, the firing clock times in FIG. 20 are not values in which the sign of the output values of the artificial neuron model have been reversed.

In this way, comparison of FIG. 19 and FIG. 20 shows that providing the delay layer 243 or the delay units 136 is effective in generating a spiking neural network 120 that is equivalent to an artificial neural network 110.

FIG. 21 is a diagram showing an example of time evolution in the membrane potential of the neuron models in an output layer in a case where a delay time is reflected. FIG. 21 shows an example of the time evolution of the membrane potential in the processing of the input data in the example of FIG. 17.

The horizontal axis of the graph in FIG. 21 represents the clock time. The vertical axis represents the membrane potential. A membrane potential value of 1.0 is set as the threshold value for firing. Furthermore, the clock times shown in FIG. 21 reflect the delay time τ or τ^{(l)}ᵢ shown in equation (18) or (20).

The line L211 represents an example of time evolution of the membrane potential of the first neuron model. The membrane potential of the first neuron model reaches the threshold at the clock time −12.263 as shown in FIG. 18.

The line L212 represents an example of time evolution of the membrane potential of the second neuron model. The membrane potential of the second neuron model reaches the threshold at the clock time −5.605 as shown in FIG. 18.

The line L213 represents an example of time evolution of the membrane potential of the third neuron model. The membrane potential of the third neuron model reaches the threshold at the clock time 18.239 as shown in FIG. 18.

In this way, the firing clock times in the case of FIG. 21 are values in which the sign of the output values of the artificial neuron model are reversed.

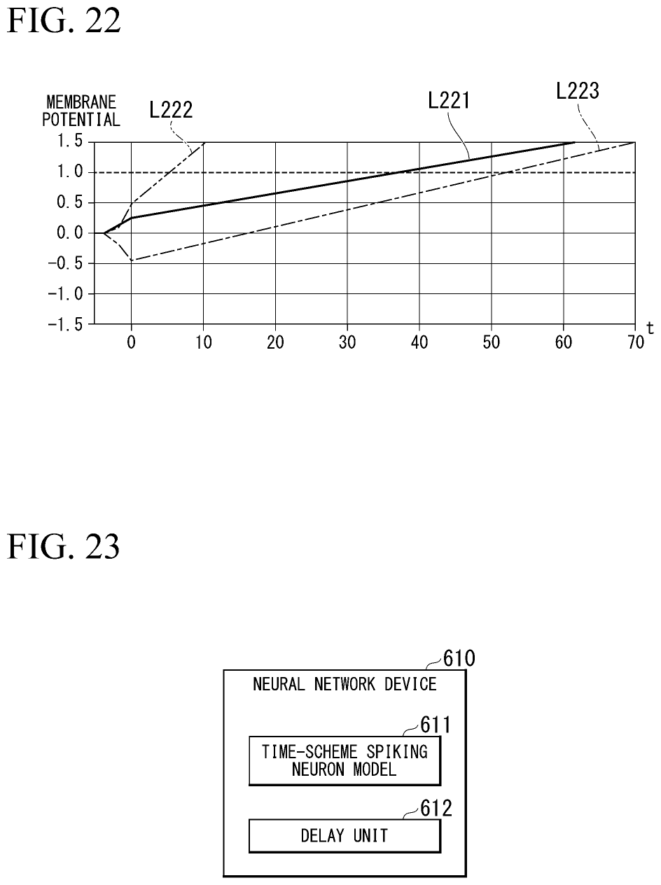

FIG. 22 is a diagram showing an example of time evolution in the membrane potential of the neuron models in an output layer in a case where a delay time is not reflected. FIG. 22 shows an example of the time evolution of the membrane potential in the processing of the input data in the example of FIG. 17.

The horizontal axis of the graph in FIG. 22 represents the clock time. The vertical axis represents the membrane potential. A membrane potential value of 1.0 is set as the threshold value for firing. Furthermore, the clock times shown in FIG. 22 do not reflect the delay time τ or τ^{(l)}ᵢ shown in equation (18) or (20).

The line L221 represents an example of time evolution of the membrane potential of the first neuron model. The line L222 represents an example of time evolution of the membrane potential of the second neuron model. The line L223 represents an example of time evolution of the membrane potential of the third neuron model.

The firing clock times in the case of FIG. 22 are different from the firing clock times in the case of FIG. 21. Therefore, the firing clock times in FIG. 22 are not values in which the sign of the output values of the artificial neuron model have been reversed.

In this way, comparing FIG. 21 and FIG. 22 shows that providing the delay layer 243 or the delay units 136 is effective in generating a spiking neural network 120 that is equivalent to an artificial neural network 110.

As described above, the time-scheme spiking neuron layer 242 outputs a signal when an internal state quantity, which evolves over time in accordance with a signal input clock time, becomes a threshold value or more. The delay layer 243 outputs a signal obtained by changing, by a set time, a spiking clock time that represents an output signal of the time-scheme spiking neuron layer 242 as a relative clock time with respect to a reference clock time.

According to the spiking neural network 120, the same processing as the artificial neural network 110 can be performed in a spiking neural network format. For example, after performing high-precision learning using the artificial neural network 110, then by implementing the equivalent spiking neural network 120 using hardware, it is possible to achieve both high-precision processing and a reduction in power consumption.

Specifically, the spiking neural network 120 that is equivalent to the artificial neural network 110 is configured by using the same number of time adjustment-type spiking neuron models 131 as the number of artificial neuron models 111 included in the artificial neural network 110. In this regard, the configuration of the spiking neural network 120 that is equivalent to the artificial neural network 110 can be made a relatively simple configuration.

Because the configuration of the spiking neural network 120 is simple, the power consumption of the spiking neural network 120 can be reduced, and the spiking neural network 120 can be made compact.

Furthermore, the weights of the input spikes to the time-scheme spiking neuron layer 242 are set to weights based on an equation that, when the spike input clock times to the time-scheme spiking neuron layer 242 are the clock times in which the sign of the numerical values represented by the input spikes have been reversed, causes the spike output clock times of the delay layer 243 to become the clock times in which the sign of the numerical values represented by the output spikes have been reversed.

As a result, the spiking neural network 120 is capable of representing positive numerical values with negative clock times. Therefore, in the spiking neural network 120, for example, by setting the lower limit of the numerical value by a ramp function or the like, the maximum value of the waiting time can be limited, and the delay due to the waiting time of the input signal can be reduced.

Moreover, the t-ReLU layer 244 outputs a signal at the earlier of the spike output clock time of the delay layer 243 and the reference clock time.

As a result, the spiking neural network 120 is capable of simulating the ramp function as the activation function of the artificial neural network 110, and can reduce the delay due to the waiting time of the input signal as described above.

Furthermore, the set spike generator 241 outputs a signal to the time-scheme spiking neuron layer 242 at a clock time that does not depend on the input spikes to the time-scheme spiking neuron layer 242.

As a result, the weights of the time-scheme spiking neuron layer 242 and the delay times of the delay layer 243 can be expressed by relatively simple equations such as equation (17) to equation (20).

In this regard, according to the spiking neural network 120, a spiking neural network that is equivalent to the artificial neural network 110 can be obtained relatively easily.

In addition, the time-scheme spiking neuron model 132 outputs a signal when an internal state quantity, which evolves over time in accordance with a signal input clock time, becomes a threshold value or more. The delay unit 136 outputs a signal obtained by changing, by a set time, a spiking clock time that is represented by an output signal of the time-scheme spiking neuron model 132 as a relative clock time with respect to a reference clock time.

As a result, the same processing as the artificial neuron model 111 can be performed by the time adjustment-type spiking neuron model 131. The artificial neural network 110 can be configured using the artificial neuron models 111. The spiking neural network 120 can be configured using the time adjustment-type spiking neuron models 131.

For example, after performing high-precision learning using the artificial neural network 110, then by implementing the equivalent spiking neural network 120 using hardware, it is possible to achieve both high-precision processing and a reduction in power consumption.

Specifically, the spiking neural network 120 that is equivalent to the artificial neural network 110 is configured by using the same number of time adjustment-type spiking neuron models 131 as the number of artificial neuron models 111 included in the artificial neural network 110. In this regard, the configuration of the spiking neural network 120, which is equivalent to the artificial neural network 110, can be made a relatively simple configuration.

Since the configuration of the spiking neural network 120 is simple, it is expected that the power consumption of the spiking neural network 120 can be reduced and the spiking neural network 120 can be made compact.

Furthermore, the weights of the input spikes to the time-scheme spiking neuron model 132 are set to weights based on an equation that, when the spike input clock times to the time-scheme spiking neuron model 132 are the clock times in which the sign of the numerical values represented by the input spikes have been reversed, causes the spike output clock times of the delay unit 136 to become the clock times in which the sign of the numerical values represented by the output spikes have been reversed.

As a result, the time adjustment-type spiking neuron model 131 is capable of representing positive numerical values with negative clock times. Therefore, in the time adjustment-type spiking neuron model 131, for example, by setting the lower limit of the numerical value by a ramp function or the like, the maximum value of the waiting time can be limited, and the delay due to the waiting time of the input signal can be reduced.

Moreover, the t-ReLU unit 137 outputs a signal at the earlier of the spike output clock time of the delay unit 136 or the reference clock time.

As a result, the time adjustment-type spiking neuron model 131 is capable of simulating the ramp function as the activation function of the artificial neuron model 111, and can reduce the delay due to the waiting time of the input signal as described above.

Furthermore, the first set spike supplying unit 135 outputs a signal to the time-scheme spiking neuron model 132 at a clock time that does not depend on the input spikes to the time-scheme spiking neuron model 132.

As a result, the weights of the time-scheme spiking neuron model 132 and the delay time of the delay unit 136 can be expressed by relatively simple equations such as equation (17) to equation (20).

In this regard, according to the time adjustment-type spiking neuron model 131, a spiking neuron model that is equivalent to the artificial neuron model 111 can be obtained relatively easily.

In addition, the base network generation unit 11 generates a spiking neural network 120 including a time-scheme spiking neuron layer 242 and a delay layer 243. The weight setting unit 12 sets the weights of the input signals to the time-scheme spiking neuron layer 242 to the times based on equation (17) or equation (19). The delay setting unit 13 sets the delay time of the delay layer 243 to the time based on equation (18) or equation (20).

According to the neural network generation device 10, a spiking neural network 120 that is equivalent to the artificial neural network 110 is obtained. For example, after performing high-precision learning using the artificial neural network 110, then by implementing the equivalent spiking neural network 120 using hardware, it is possible to achieve both high-precision processing and a reduction in power consumption.

Specifically, the spiking neural network 120 that is equivalent to the artificial neural network 110 is configured by using the same number of time adjustment-type spiking neuron models 131 as the number of artificial neuron models 111 included in the artificial neural network 110. In this regard, the configuration of the spiking neural network 120, which is equivalent to the artificial neural network 110, can be made a relatively simple configuration.

Since the configuration of the spiking neural network 120 is simple, the power consumption of the spiking neural network 120 can be reduced, and the spiking neural network 120 can be made compact.

Furthermore, the base model generation unit 21 generates a time adjustment-type spiking neuron model 131 including a time-scheme spiking neuron model 132 and a delay unit 136. The weight setting unit 22 sets the weights of the input signals to the time-scheme spiking neuron model 132 to the times based on equation (17) or equation (19). The delay setting unit 23 sets the delay time of the delay unit 136 to the time based on equation (18) or equation (20).

According to the neuron model generation device 20, a time adjustment-type spiking neuron model 131 that is equivalent to the artificial neuron model 111 is obtained. The artificial neural network 110 can be configured using the artificial neuron models 111. The spiking neural network 120 can be configured using the time adjustment-type spiking neuron models 131.

For example, after performing high-precision learning using the artificial neural network 110, then by implementing the equivalent spiking neural network 120 using hardware, it is possible to achieve both high-precision processing and a reduction in power consumption.

Specifically, the spiking neural network 120 that is equivalent to the neural network 110 is configured by using the same number of time adjustment-type spiking neuron models 131 as the number of artificial neuron models 111 included in the artificial neural network 110. In this regard, the configuration of the spiking neural network 120, which is equivalent to the artificial neural network 110, can be made a relatively simple configuration.

Since the configuration of the spiking neural network 120 is simple, it is expected that the power consumption of the spiking neural network 120 can be reduced and the spiking neural network 120 can be made compact.

FIG. 23 is a diagram showing a configuration example of a neural network device according to an example embodiment. In the configuration shown in FIG. 23, the neural network device 610 includes a time-scheme spiking neuron model 611 and a delay unit 612.

In this configuration, the time-scheme spiking neuron model 611 outputs a signal when an internal state quantity, which evolves over time in accordance with a signal input clock time, becomes a threshold value or more. The delay unit 612 outputs a signal obtained by changing, by a set time, a spike clock time that is represented by an output signal of the time-scheme spiking neuron model 611 as a relative clock time with respect to a reference clock time.

According to the neural network device 610, the same processing as the artificial neural network can be performed in a spiking neural network format. For example, after performing high-precision learning using the artificial neural network, by implementing a spiking neural network in the equivalent neural network device 610 using hardware, it is possible to achieve both high-precision processing and a reduction in power consumption.

Specifically, the neural network device 610 that is equivalent to the neural network is configured by using the same number of neuron models as the number of artificial neuron models included in the artificial neural network. In this regard, the configuration of the spiking neural network, which is equivalent to the artificial neural network, can be made a relatively simple configuration.

Since the configuration of the neural network device 610 is simple, the power consumption of the neural network device 610 can be reduced, and the neural network device 610 can be made compact.

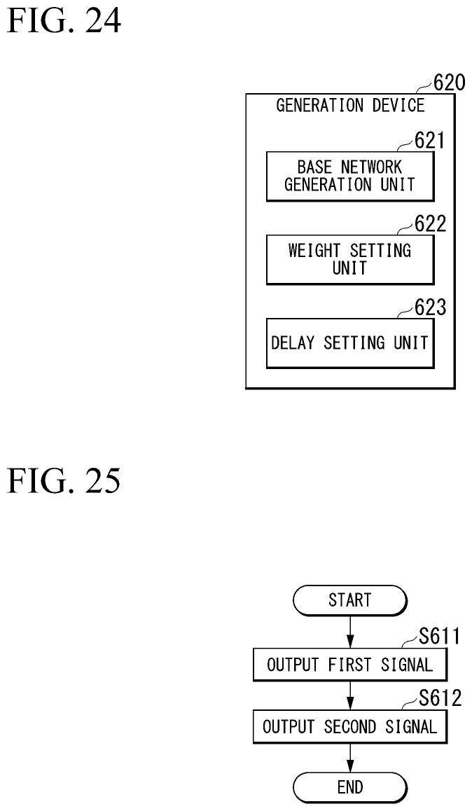

FIG. 24 is a diagram showing a configuration example of a generation device according to an example embodiment. In the configuration shown in FIG. 24, the generation device 620 includes a base network generation unit 621, a weight setting unit 622, and a delay setting unit 623.

In this configuration, the base network generation unit 621 generates a neural network that includes: a time-scheme spiking neuron model that outputs a signal when an internal state quantity, which evolves over time in accordance with a signal input clock time, becomes a threshold value or more; and a delay unit that outputs a signal obtained by changing, by a set time, a spike clock time that is represented by an output signal of the time-scheme spiking neuron model means as a relative clock time with respect to a reference clock time.

The weight setting unit 622 sets a weight of an input signal to the time-scheme spiking neuron model to a weight based on an equation such that, when an input clock time of the input signal is a clock time in which a sign of a numerical value represented by the input signal is reversed, an output clock time of an output signal of the delay unit becomes a clock time in which a sign of a numerical value represented by the output signal is reversed.

The delay setting unit 623 sets the set time in the delay unit to a time based on an equation such that, when an input clock time of an input signal to the time-scheme spiking neuron model means is a clock time in which a sign of a numerical value represented by the input signal is reversed, an output clock time of an output signal of the delay unit becomes a clock time in which a sign of a numerical value represented by the output signal is reversed.

According to the generation device 620, a neural network device is obtained in the form of a spiking neural network that is equivalent to an artificial neural network. For example, after performing high-precision learning using the artificial neural network, then by implementing the equivalent neural network device using hardware, it is possible to achieve both high-precision processing and a reduction in power consumption.

Specifically, the neural network device that is equivalent to the artificial neural network is configured by using the same number of spiking neuron models as the number of artificial neuron models included in the artificial neural network. In this regard, the configuration of the spiking neural network, which is equivalent to the artificial neural network, can be made a relatively simple configuration.

Since the configuration of the neural network device is simple, it is expected that the power consumption of the neural network device can be reduced and the spiking neural network 120 can be made compact.

FIG. 25 is a diagram showing an example of the processing procedure of an information processing method according to an example embodiment. The method shown in FIG. 25 includes outputting a first signal (step S611) and outputting a second signal (step S612).

In outputting a first signal (step S611), a first signal is output when an internal state quantity, which evolves over time in accordance with a signal input clock time, becomes a threshold value or more. In outputting a second signal (step S612), a second signal is output which is obtained by changing, by a set time, a spike clock time that is represented by the first signal as a relative clock time with respect to a reference clock time.

According to the method shown in FIG. 25, the same processing as the artificial neural network can be performed in a spiking neural network format. For example, after performing high-precision learning using the artificial neural network, then by implementing the equivalent spiking neural network using hardware and performing the processing of FIG. 25, it is possible to achieve both high-precision processing and a reduction in power consumption.

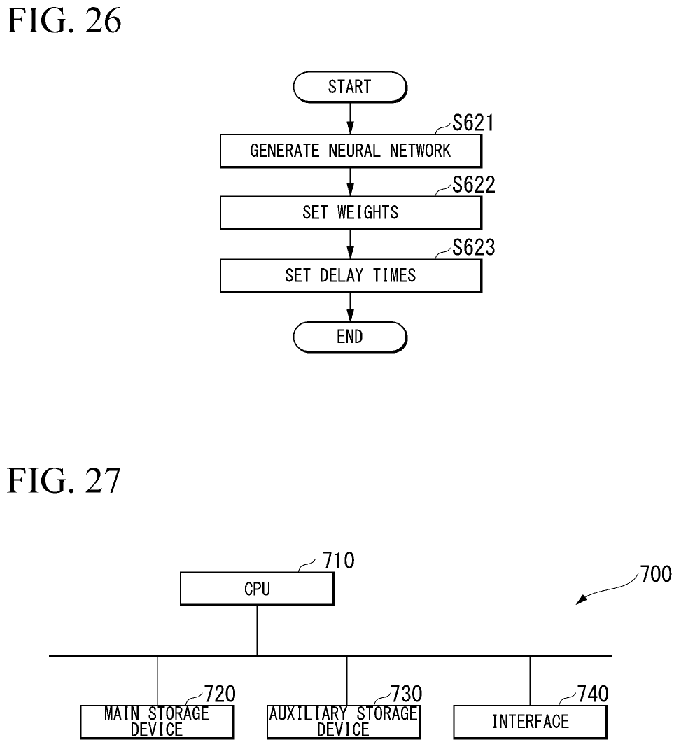

FIG. 26 is a diagram showing an example of the processing procedure of a generation method according to an example embodiment. The method shown in FIG. 26 includes generating a neural network (step S621), setting a weight (step S622), and setting a delay (step S623).

In generating a neural network (step S621), a neural network is generated that includes: a time-scheme spiking neuron model means that outputs a signal when an internal state quantity, which evolves over time in accordance with a signal input clock time, becomes a threshold value or more; and a delay means that outputs a signal obtained by changing, by a set time, a spike clock time that is represented by an output signal of the time-scheme spiking neuron model means as a relative clock time with respect to a reference clock time.

In setting a weight (step S622), a weight of an input signal to the time-scheme spiking neuron model means is set to a weight based on an equation such that, when an input clock time of the input signal is a clock time in which a sign of a numerical value represented by the input signal is reversed, an output clock time of an output signal of the delay means becomes a clock time in which a sign of a numerical value represented by the output signal is reversed.

In setting a delay (step S623), the set time in the delay means is set to a time based on an equation such that, when an input clock time of an input signal to the time-scheme spiking neuron model means is a clock time in which a sign of a numerical value represented by the input signal is reversed, an output clock time of an output signal of the delay means becomes a clock time in which a sign of a numerical value represented by the output signal is reversed.

According to the method described in FIG. 26, a spiking neural network that is equivalent to the artificial neural network is obtained. For example, after performing high-precision learning using the artificial neural network, then by implementing the equivalent spiking neural network using hardware, it is possible to achieve both high-precision processing and a reduction in power consumption.

Specifically, the spiking neural network that is equivalent to the artificial neural network is configured by using the same number of spiking neuron models as the number of artificial neuron models included in the artificial neural network. In this regard, the configuration of the spiking neural network, which is equivalent to the artificial neural network, can be made a relatively simple configuration.

Since the configuration of the spiking neural network is simple, the power consumption of the spiking neural network can be reduced, and the spiking neural network can be made compact.

FIG. 27 is a schematic block diagram showing a configuration of a computer according to at least one example embodiment.

In the configuration shown in FIG. 27, the computer 700 includes a CPU 710, a main storage device 720, an auxiliary storage device 730, and an interface 740.

Any one or more of the neural network generation device 10, the spiking neural network 120, the time adjustment-type spiking neuron model 131, the neuron model generation device 20, the neural network device 610, and the generation device 620, or a part thereof, may be implemented by the computer 700. In this case, the operation of each of the processing units described above is stored in the auxiliary storage device 730 in the form of a program. The CPU 710 reads the program from the auxiliary storage device 730, expands the program in the main storage device 720, and executes the processing described above according to the program. Further, the CPU 710 reserves a storage area corresponding to each of the storage units in the main storage device 720 according to the program. The communication of each device with other devices is executed as a result of the interface 740 having a communication function and performing communication according to the control of the CPU 710.

When the neural network generation device 10 is implemented by the computer 700, the operation of each of the base network generation unit 11, the weight setting unit 12, and the delay setting unit 13 is stored in the auxiliary storage device 730 in the form of a program. The CPU 710 reads the program from the auxiliary storage device 730, expands the program in the main storage device 720, and executes the processing described above according to the program.

Furthermore, the CPU 710 reserves a storage area for the processing performed by the neural network generation device 10 in the main storage device 720 according to the program.

The communication between the neural network generation device 10 and other devices is executed, for example, as a result of the interface 740 including a communication function and operating under the control of the CPU 710.

The interactions between the neural network generation device 10 and the user are executed as a result of the interface 740 having a display screen, which displays various images under the control of the CPU 710, and the interface 740 having an input device such as a keyboard that accepts user operations.

When the spiking neural network 120 is implemented by the computer 700, the operation of each of the set spike generator 241, the time-scheme spiking neuron layer 242, the delay layer 243, and the t-ReLU layer 244 is stored in the auxiliary storage device 730 in the form of a program. The CPU 710 reads the program from the auxiliary storage device 730, expands the program in the main storage device 720, and executes the processing described above according to the program.

Furthermore, the CPU 710 reserves a storage area for the processing performed by the spiking neural network 120 in the main storage device 720 according to the program.

The communication between the spiking neural network 120 and other devices is executed, for example, as a result of the interface 740 including a communication function and operating under the control of the CPU 710.

The interactions between the spiking neural network 120 and the user are executed as a result of the interface 740 having a display screen, which displays various images under the control of the CPU 710, and the interface 740 having an input device such as a keyboard that accepts user operations.

When the time adjustment-type spiking neuron model 131 is implemented by the computer 700, the operation of each of the time-scheme spiking neuron model 132, the first set spike supplying unit 135, the delay unit 136, the t-ReLU unit 137, and the second set spike supplying unit 138 is stored in the auxiliary storage device 730 in the form of a program. The CPU 710 reads the program from the auxiliary storage device 730, expands the program in the main storage device 720, and executes the processing described above according to the program.

Furthermore, the CPU 710 reserves a storage area for the processing performed by the time adjustment-type spiking neuron model 131 in the main storage device 720 according to the program.

The communication between the time adjustment-type spiking neuron model 131 and other devices is executed, for example, as a result of the interface 740 including a communication function and operating under the control of the CPU 710.

The interactions between the time adjustment-type spiking neuron model 131 and the user are executed as a result of the interface 740 having a display screen, which displays various images under the control of the CPU 710, and the interface 740 having an input device such as a keyboard that accepts user operations.

When the neuron model generation device 20 is implemented by the computer 700, the operation of each of the base model generation unit 21, the weight setting unit 22, and the delay setting unit 23 is stored in the auxiliary storage device 730 in the form of a program. The CPU 710 reads the program from the auxiliary storage device 730, expands the program in the main storage device 720, and executes the processing described above according to the program.

Furthermore, the CPU 710 reserves a storage area for the processing performed by the neuron model generation device 20 in the main storage device 720 according to the program.

The communication between the neuron model generation device 20 and other devices is executed, for example, as a result of the interface 740 including a communication function and operating under the control of the CPU 710.

The interactions between the neuron model generation device 20 and the user are executed as a result of the interface 740 having a display screen, which displays various images under the control of the CPU 710, and the interface 740 having an input device such as a keyboard that accepts user operations.

When the neural network device 610 is implemented by the computer 700, the operation of each of the time-scheme spiking neuron model 611 and the delay unit 612 is stored in the auxiliary storage device 730 in the form of a program. The CPU 710 reads the program from the auxiliary storage device 730, expands the program in the main storage device 720, and executes the processing described above according to the program.

Furthermore, the CPU 710 reserves a storage area for the processing performed by the neural network device 610 in the main storage device 720 according to the program.

The communication between the neural network device 610 and other devices is executed, for example, as a result of the interface 740 including a communication function and operating under the control of the CPU 710.

The interactions between the neural network device 610 and the user are executed as a result of the interface 740 having a display screen, which displays various images under the control of the CPU 710, and the interface 740 having an input device such as a keyboard that accepts user operations.

When the generation device 620 is implemented by the computer 700, the operation of each of the base network generation unit 621, the weight setting unit 622, and the delay setting unit 623 is stored in the auxiliary storage device 730 in the form of a program. The CPU 710 reads the program from the auxiliary storage device 730, expands the program in the main storage device 720, and executes the processing described above according to the program.

Furthermore, the CPU 710 reserves a storage area for the processing performed by the generation device 620 in the main storage device 720 according to the program.

The communication between the generation device 620 and other devices is executed, for example, as a result of the interface 740 including a communication function and operating under the control of the CPU 710.

The interactions between the generation device 620 and the user are executed as a result of the interface 740 having a display screen, which displays various images under the control of the CPU 710, and the interface 740 having an input device such as a keyboard that accepts user operations.

A program for executing some or all of the processing performed by the neural network generation device 10, the spiking neural network 120, the time adjustment-type spiking neuron model 131, the neuron model generation device 20, the neural network device 610, and the generation device 620 may be recorded on a computer-readable recording medium, and the processing of each unit may be performed by a computer system reading and executing the program recorded on the recording medium. The “computer system” referred to here is assumed to include an OS and hardware such as a peripheral device.

Furthermore, the “computer-readable recording medium” refers to a portable medium such as a flexible disk, a magnetic optical disk, a ROM (Read Only Memory), or a CD-ROM (Compact Disc Read Only Memory), or a storage device such as a hard disk built into a computer system. Moreover, the program may be one capable of realizing some of the functions described above. Further, the functions described above may be realized in combination with a program already recorded in the computer system.

The example embodiments of the present invention have been described in detail above with reference to the drawings. However, specific configurations are in no way limited to the example embodiments, and include designs and the like within a scope not departing from the spirit of the present invention.

### INDUSTRIAL APPLICABILITY

The example embodiments of the present invention may be applied to a neural network device, a generation device, an information processing method, a generation method, and a recording medium.

### DESCRIPTION OF REFERENCE SIGNS

10 Neural network generation device

11, 621 Base network generation unit

12, 22, 622 Weight setting unit

13, 23, 623 Delay setting unit

20 Neuron model generation device

21 Base model generation unit

110 Artificial neural network

120 Spiking neural network

121 Spiking neuron model

131 Time adjustment-type spiking neuron model

132, 611 Time-scheme spiking neuron model

133 Membrane potential computation unit

134 Spike generation unit

135 First set spike supplying unit

136, 612 Delay unit

137 t-ReLU unit

138 Second set spike supplying unit

241 Set spike generator

242 Time-scheme spiking neuron layer

243 Delay layer

244 t-ReLU layer

610 Neural network device

620 Generation device

What is claimed is:

1. A neural network device comprising:
a time-scheme spiking neuron model hat outputs a signal when an internal state quantity that evolves over time in accordance with a signal input clock time, becomes a threshold value or more; and
a delay unit that outputs a signal obtained by changing, by a set time, a spike clock time that is represented by the output signal of the time-scheme spiking neuron model unit as a relative clock time with respect to a reference clock time.

2. The neural network device according to claim 1, wherein a weight of an input signal to the time-scheme spiking neuron model is set to a weight based on an equation in which, when an input clock time of the input signal is a clock time in which a sign of a numerical value represented by the input signal is reversed, an output clock time of an output signal of the delay unit becomes a clock time in which a sign of a numerical value represented by the output signal is reversed.

3. The neural network device according to claim 2, further comprising:
a time-scheme ramp function unit that outputs a signal at earlier of an output clock time of the output signal of the delay unit or the reference clock time.

4. A neural network device according to claim 1, further comprising:
a set spike supplying unit that outputs a signal to the time-scheme spiking neuron model at a clock time that does not depend on an input signal to the time-scheme spiking neuron model.

5. The neural network device according to claim 1, wherein at least either the time-scheme spiking neuron model and the delay unit is configured using an (Application Specific Integrated Circuit (ASIC) or (a Field-Programmable Gate Array (FPGA).

6. A generation device comprising:
a base network generating unit that generates a neural network, the neural network including a time-scheme spiking neuron model that outputs a signal when an internal state quantity that evolves over time in accordance with a signal input clock time, becomes a threshold value or more, and a delay unit that outputs a signal obtained by changing, by a set time, a spike clock time that is represented by the output signal of the time-scheme spiking neuron model as a relative clock time with respect to a reference clock time;
a weight setting unit that sets a weight of an input signal to the time-scheme spiking neuron model to a weight based on an equation in which, when an input clock time of the input signal is a clock time in which a sign of a numerical value represented by the input signal is reversed, an output clock time of an output signal of the delay unit becomes a clock time in which a sign of a numerical value represented by the output signal is reversed; and
a delay setting unit that sets the set time of the delay unit to a time based on an equation in which, when an input clock time of an input signal to the time-scheme spiking neuron model is a clock time in which a sign of a numerical value represented by the input signal is reversed, an output clock time of an output signal of the delay unit becomes a clock time in which a sign of a numerical value represented by the output signal is reversed.

7. An information processing method comprising:
outputting a first signal when an internal state quantity that evolves over time in accordance with a signal input clock time, becomes a threshold value or more; and
outputting a second signal obtained by changing, by a set time, a spike clock time that is represented by the first signal as a relative clock time with respect to a reference clock time.

8-10. (canceled)
